(19) United States
(12) Patent Application Publication
(10) Pub. No.: US 2024/0154101 A1
(43) Pub. Date: May 9, 2024

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Yosuke KOIKE, Kyoto (JP)

(21) Appl. No.: 18/411,508

(22) Filed: Jan. 12, 2024

Related U.S. Application Data
(63) Continuation of application No. PCT/JP2022/025504, filed on Jun. 27, 2022.

(30) Foreign Application Priority Data
Jul. 13, 2021 (JP) 2021-115818

(51) Int. Cl. H01M 4/36; H01M 4/133; H01M 4/134; H01M 4/38; H01M 4/587; H01M 10/0525; H01M 4/02

(52) U.S. Cl. CPC H01M 4/366; H01M 4/133; H01M 4/134; H01M 4/386; H01M 4/587; H01M 10/0525; H01M 2004/021; H01M 2004/027

(57) ABSTRACT

A secondary battery includes a positive electrode, a negative electrode, a separator, and an electrolytic solution. The negative electrode includes fiber parts and covering parts, and has voids. The separator is disposed between the positive electrode and the negative electrode. The fiber parts are coupled to each other to thereby form a three-dimensional mesh structure having the voids. The fiber parts each include carbon as a constituent element. The covering parts each cover a surface of corresponding one of the fiber parts, and each include silicon as a constituent element. Where the negative electrode is bisected into a first part and a second part in a direction in which the positive electrode and the negative electrode are opposed to each other with the separator interposed between the positive electrode and the negative electrode, at least one of an average fiber diameter of the fiber parts, a proportion of a weight of the covering parts to a sum of a weight of the fiber parts and the weight of the covering parts, or a void rate varies between the first part and the second part. The first part is positioned on a side close to the separator. The second part is positioned on a side far from the separator.

### CROSS REFERENCE TO RELATED APPLICATIONS

The present application is a continuation of PCT patent application no. PCT/JP2022/025504, filed on Jun. 27, 2022, which claims priority to Japanese patent application no. 2021-115818, filed on Jul. 13, 2021, the entire contents of which are incorporated herein by reference.

### BACKGROUND

The present application relates to a negative electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte. A configuration of the secondary battery has been considered in various ways.

For example, as a material to be included in a negative electrode for a lithium-ion secondary battery, a carbonaceous conductive porous substrate, a conductive material (e.g., a carbon nanotube), and an active material (e.g., silicon) are used, and a porosity (a void rate) of the negative electrode is defined.

As a material to be included in a negative electrode for a lithium-ion secondary battery, a conducting substrate such as carbon fibers covered with, for example, silicon, is used and a content (a weight ratio) of silicon in the negative electrode is defined.

As a material to be included in a negative electrode for a lithium-ion secondary battery, a copper current collector and porous silicon having a three-dimensional mesh structure covered with an electrically conductive substance such as a carbon material are used, and an average void rate of the porous silicon is defined.

Inside a negative electrode for a lithium-ion secondary battery, a content of silicon, a content of a carbon material, and a pore rate each have a gradient distribution.

### SUMMARY

The present application relates to a negative electrode for a secondary battery, and a secondary battery.

Consideration has been given in various ways regarding a configuration of a secondary battery; however, an initial capacity characteristic, a load characteristic, and a cyclability characteristic of the secondary battery still remain insufficient. Accordingly, there is room for improvement in terms thereof.

It is therefore desirable to provide a negative electrode for a secondary battery that makes it possible to achieve a superior initial capacity characteristic, a superior load characteristic, and a superior cyclability characteristic.

A negative electrode for a secondary battery according to an embodiment of the present technology includes fiber parts and covering parts, and has voids. The fiber parts are coupled to each other to thereby form a three-dimensional mesh structure having the voids. The fiber parts each include carbon as a constituent element. The covering parts each cover a surface of corresponding one of the fiber parts, and each include silicon as a constituent element. Where the negative electrode is bisected into a first part and a second part in a thickness direction, at least one of an average fiber diameter of the fiber parts, a proportion of a weight of the covering parts to a sum of a weight of the fiber parts and the weight of the covering parts, or a void rate varies between the first part and the second part.

A secondary battery according to an embodiment of the present technology includes a positive electrode, a negative electrode, a separator, and an electrolytic solution. The negative electrode includes fiber parts and covering parts, and has voids. The separator is disposed between the positive electrode and the negative electrode. The fiber parts are coupled to each other to thereby form a three-dimensional mesh structure having the voids. The fiber parts each include carbon as a constituent element. The covering parts each cover a surface of corresponding one of the fiber parts, and each include silicon as a constituent element. Where the negative electrode is bisected into a first part and a second part in a direction in which the positive electrode and the negative electrode are opposed to each other with the separator interposed between the positive electrode and the negative electrode, at least one of an average fiber diameter of the fiber parts, a proportion of a weight of the covering parts to a sum of a weight of the fiber parts and the weight of the covering parts, or a void rate varies between the first part and the second part. The first part is positioned on a side close to the separator. The second part is positioned on a side far from the separator.

A description will be given later as to details (e.g., definitions and calculation procedures) of each of three physical property values, i.e., the “average fiber diameter of the fiber parts”, the “proportion of the weight of the covering parts to the sum of the weight of the fiber parts and the weight of the covering parts”, and the “void rate” described above.

A description will be given later as to details (e.g., definitions) of the statement of “at least one of the average fiber diameter of the fiber parts, the proportion of the weight of the covering parts to the sum of the weight of the fiber parts and the weight of the covering parts, or the void rate varies between the first part and the second part”.

According to an embodiment of the present technology, the negative electrode for a secondary battery includes the fiber parts and the covering parts described above and has the voids; and at least one of the average fiber diameter, the proportion, or the void rate described above varies between the first part and the second part. This makes it possible to achieve a superior initial capacity characteristic, a superior load characteristic, and a superior cyclability characteristic.

Note that effects of the present technology are not necessarily limited to those described herein and may include any suitable effect, including described below, in relation to the present technology.

### BRIEF DESCRIPTION OF THE FIGURES

FIG. 1 is a schematic diagram illustrating a configuration of a negative electrode for a secondary battery according to an embodiment of the present technology.

FIG. 2 is an enlarged sectional diagram illustrating a configuration of each of a carbon fiber part and a covering part illustrated in FIG. 1.

FIG. 3 is another schematic diagram illustrating the configuration of the negative electrode for a secondary battery.

FIG. 4 is a perspective diagram illustrating a configuration of a secondary battery according to an embodiment of the present technology.

FIG. 5 is an enlarged sectional diagram illustrating a configuration of a battery device illustrated in FIG. 4.

FIG. 6 is a sectional diagram illustrating a configuration of a negative electrode for a secondary battery according to an embodiment.

FIG. 7 is a schematic diagram illustrating a configuration of a negative electrode for a secondary battery according to an embodiment.

FIG. 8 is a block diagram illustrating a configuration of an application example of the secondary battery.

### DETAILED DESCRIPTION

The present technology will be described below in further detail including with reference to the drawings according to an embodiment.

A description is given first of a negative electrode for a secondary battery (hereinafter, simply referred to as a “negative electrode”) according to an embodiment of the present technology.

The negative electrode is to be used in a secondary battery, which is an electrochemical device. However, the negative electrode may be used in any of electrochemical devices other than the secondary battery. Such other electrochemical devices are not particularly limited in kind, and specific examples thereof include a capacitor.

In the electrochemical device such as the secondary battery described above, the negative electrode allows for insertion of an electrode reactant into the negative electrode and extraction of the electrode reactant from the negative electrode upon an electrode reaction. The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

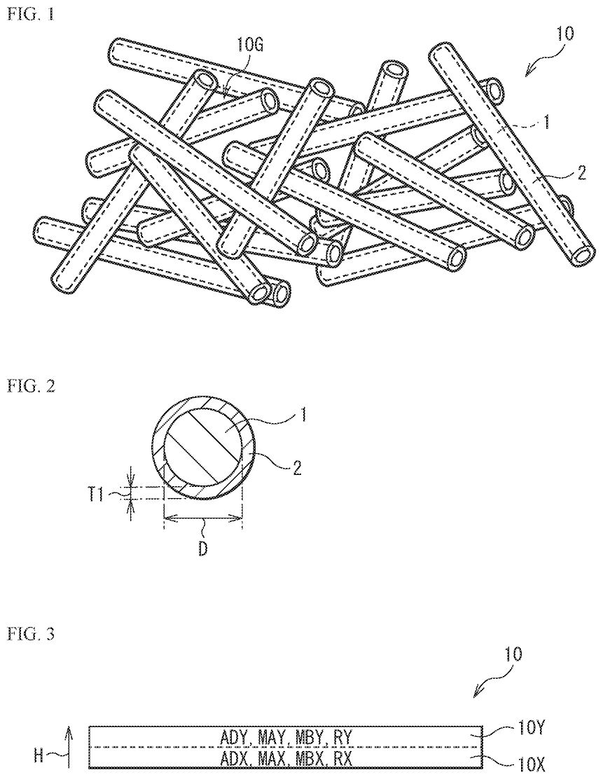

FIG. 1 schematically illustrates a configuration of a negative electrode 10 as an example of the negative electrode. FIG. 2 illustrates an enlarged sectional configuration of each of a carbon fiber part 1 and a covering part 2 illustrated in FIG. 1. Note that FIG. 1 illustrates only a portion of the negative electrode 10, and FIG. 2 illustrates a section of each of the carbon fiber part 1 and the covering part 2 intersecting a longitudinal direction of the carbon fiber part 1.

As illustrated in FIG. 1, the negative electrode 10 includes multiple carbon fiber parts 1 and multiple covering parts 2, and has multiple voids 10G. That is, the negative electrode 10 does not include a current collector (hereinafter referred to as a “metal current collector”) such as a metal foil. The negative electrode 10 is thus a metal current collector-less electrode.

As illustrated in FIG. 1, the carbon fiber parts 1 are fiber parts that have an average fiber diameter AD. As illustrated in FIG. 2, the carbon fiber parts 1 each have a fiber diameter D. The carbon fiber parts 1 are coupled to each other to thereby form a three-dimensional mesh structure having the voids TOG described above.

For simplifying illustration, FIG. 1 illustrates a case where the carbon fiber parts 1 each have a linear shape. However, a state (a shape) of each of the carbon fiber parts 1 is not particularly limited, and is thus not limited to the linear shape. The carbon fiber parts 1 may each be curved, branched, or in a mixture state including two or more of such different shapes.

Here, the carbon fiber parts 1 are coupled to each other to form the three-dimensional mesh structure, as described above. More specifically, the carbon fiber parts 1 are randomly entangled with each other. Note that the carbon fiber parts 1 may be bound to each other via an unillustrated carbide such as a polymer compound. As a result, the carbon fiber parts 1 have multiple junctions, and any two of the carbon fiber parts 1 are electrically continuous with each other at each of the junctions.

The carbon fiber parts 1 each include carbon as a constituent element. Thus, the carbon fiber parts 1 each include what is called a carbon-containing material. The term “carbon-containing material” is a generic term for a material that includes carbon as a constituent element.

Specifically, the carbon fiber parts 1 include a carbon paper. A reason for this is that this allows the carbon fiber parts 1 to be sufficiently coupled to each other and to be sufficiently great in the average fiber diameter AD, thus allowing for formation of a sufficient electrically conductive network (three-dimensional mesh structure).

Note that the carbon fiber parts 1 may include a material that is processed to allow multiple fibers of a fibrous carbon material having the above-described average fiber diameter AD to form a three-dimensional mesh structure. The kind of the fibrous carbon material is not particularly limited, and specific examples thereof include a vapor-grown carbon fiber (VGCF), a carbon fiber (CF), and a carbon nanofiber (CNF). Other possible kinds of the fibrous carbon material include a carbon nanotube (CNT). The carbon nanotube may be a single-walled carbon nanotube (a single-wall carbon nanotube (SWCNT)), or may be a multi-walled carbon nanotube (a multi-wall carbon nanotube (MWCNT)) such as a double-walled carbon nanotube (a double-wall carbon nanotube (DWCNT)).

Here, the average fiber diameter AD (nm) of the carbon fiber parts 1 satisfies a predetermined condition. The predetermined condition will be described later in detail.

As illustrated in FIG. 1, the covering parts 2 each cover a surface of corresponding one of the carbon fiber parts 1. As illustrated in FIG. 2, the covering parts 2 each have a thickness T1.

The covering part 2 may entirely cover the surface of the carbon fiber part 1, or may partially cover the surface of the carbon fiber part 1. In the latter case, multiple covering parts 2 may cover the surface of the carbon fiber part 1 at multiple locations separate from each other. For simplifying illustration, FIG. 1 illustrates a case where the covering parts 2 entirely cover the surfaces of the carbon fiber parts 1.

Further, the covering parts 2 each include silicon as a constituent element. Thus, the covering parts 2 each include what is called a silicon-containing material. A reason for this is that a high energy density is obtainable owing to superior electrode-reactant insertability and superior electrode-reactant extractability of silicon.

The term “silicon-containing material” is a generic term for a material that includes silicon as a constituent element. The silicon-containing material may thus be a simple substance of silicon, a silicon alloy, a silicon compound, a mixture of two or more thereof, or a material including one or more phases thereof. Note that the simple substance of silicon may include a small amount of impurity. In other words, a purity of the simple substance of silicon is not limited to 100%. Examples of the impurity include an impurity that is unintentionally included during a process of manufacturing the simple substance of silicon, and an oxide that is unintentionally formed due to oxygen in the atmosphere. A content of the impurity in the simple substance of silicon is preferably as low as possible, and is more preferably 5 wt % or less.

The silicon alloy includes any one or more of metallic elements including, without limitation, tin, nickel, copper, iron, cobalt, manganese, zinc, indium, silver, titanium, germanium, bismuth, antimony, and chromium, as one or more constituent elements other than silicon. The silicon compound includes any one or more of non-metallic elements including, without limitation, carbon and oxygen, as one or more constituent elements other than silicon. Note that the silicon compound may further include, as one or more constituent elements other than silicon, any one or more of the series of metallic elements described above in relation to the silicon alloy.

Specific examples of the silicon alloy include Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WS₁₂, ZnSi₂, and SiC. Note that a composition of the silicon alloy, i.e., a mixture ratio between silicon and the one or more metallic elements, may be varied as desired.

Specific examples of the silicon compound include SiB₄, SiB₆, Si₃N₄, Si₂N₂O, SiOᵥ (where 0<v≤2), and LiSiO. Note that “v” may be within the following range: 0.2<v<1.4.

The silicon-containing material is preferably the simple substance of silicon, in particular. A reason for this is that a higher energy density is obtainable. In this case, a content of silicon in each of the covering parts 2, that is, a content (a purity) of silicon in the silicon-containing material, is preferably 80 wt % or more, and more preferably within a range from 80 wt % to 100 wt % both inclusive, in particular, although not particularly limited thereto. A reason for this is that a markedly high energy density is obtainable.

Note that although not specifically illustrated here, in addition, a portion or all of the surface of the covering part 2 may be covered with a covering layer. The covering layer includes any one or more of electrically conductive materials including, without limitation, the carbon-containing material and a metal material. A reason for this is that this further improves electrical conductivity of the negative electrode 10. Details of the carbon-containing material are as described above. The metal material is not particularly limited in kind.

When forming the covering layer, for example, a silane coupling agent and a polymer-based material are used. A reason for this is to sufficiently cover the surface of the covering part 2 by using the covering layer. Covering the surface of the covering part 2 sufficiently by using the covering layer suppresses a decomposition reaction of an electrolytic solution at the surface of the covering part 2 including the silicon-containing material.

Here, a weight proportion MA (wt %), i.e., a proportion of a weight M2 of the covering parts 2 to a sum of a weight M1 of the carbon fiber parts 1 and the weight M2 of the covering parts 2, satisfies a predetermined condition. The weight proportion MA is calculated based on the following calculation expression: MA=[M2/(M1+M2)]×100. The predetermined condition will be described later in detail.

As described above, the negative electrode 10 includes the three-dimensional mesh structure formed by the carbon fiber parts 1, and thus has the voids 10G.

Here, a void rate R (vol %) determined based on the voids 10G satisfies a predetermined condition. The predetermined condition will be described later in detail.

Note that the negative electrode 10 may further include any one or more of other materials.

Such other materials are not particularly limited in kind, and specific examples thereof include a binder. A reason for this is that the carbon fiber parts 1 and the covering parts 2 are firmly couplable to each other via the binder, which allows for formation of a firm electrically conductive network.

The binder includes any one or more of polymer compounds. Specific examples of the polymer compounds include polyimide, polyvinylidene difluoride, a polyacrylic acid, a styrene-butadiene rubber, and carboxymethyl cellulose.

The configuration of the negative electrode 10 satisfies a predetermined condition, as will be described below.

FIG. 3 schematically illustrates another configuration of the negative electrode 10. Note that, unlike FIG. 1, FIG. 3 illustrates the entire negative electrode 10.

As illustrated in FIG. 3, the negative electrode 10 has a substantially plate-shaped structure or a substantially sheet-shaped structure, and therefore has a thickness. The thickness refers to a dimension in a vertical direction, i.e., in a thickness direction H, in FIG. 3.

Here, when focusing on three physical property values defining the configuration of the negative electrode 10, i.e., the average fiber diameter AD, the weight proportion MA, and the void rate R, the three physical property values satisfy the predetermined conditions. Specifically, where the negative electrode 10 is bisected into a lower part 10X (a first part) and an upper part 10Y (a second part) in the thickness direction H, one or more of the average fiber diameter AD, the weight proportion MA, or the void rate R vary between the lower part 10X and the upper part 10Y. In FIG. 3, for easier distinction between the lower part 10X and the upper part 10Y, a dashed line is drawn at a border between the lower part 10X and the upper part 10Y.

That is, the average fiber diameter AD may vary between the lower part 10X and the upper part 10Y. Alternatively, the weight proportion MA may vary between the lower part 10X and the upper part 10Y. Alternatively, the void rate R may vary between the lower part 10X and the upper part 10Y. Needless to say, any two or more of the average fiber diameter AD, the weight proportion MA, or the void rate R may vary between the lower part 10X and the upper part 10Y, or all of the average fiber diameter AD, the weight proportion MA, and the void rate R may vary between the lower part 10X and the upper part 10Y.

When the average fiber diameter AD varies between the lower part 10X and the upper part 10Y, a variation tendency of the average fiber diameter AD is not particularly limited. Accordingly, the average fiber diameter AD may vary discontinuously in the thickness direction H, or may vary continuously in the thickness direction H.

The description above provided in relation to the variation tendency of the average fiber diameter AD is similarly applicable to each of a variation tendency of the weight proportion MA and a variation tendency of the void rate R.

That is, when the weight proportion MA varies between the lower part 10X and the upper part 10Y, the weight proportion MA may vary discontinuously in the thickness direction H, or may vary continuously in the thickness direction H.

When the void rate R varies between the lower part 10X and the upper part 10Y, the void rate R may vary discontinuously in the thickness direction H, or may vary continuously in the thickness direction H.

Note that the lower part 10X and the upper part 10Y may be provided separately from each other, or may be integrated with each other. When the lower part 10X and the upper part 10Y are provided separately from each other, the negative electrode 10 has a two-layered structure, and the lower part 10X and the upper part 10Y thus have a physical (real) interface at the border therebetween. In contrast, when the lower part 10X and the upper part 10Y are integrated with each other, the negative electrode 10 has a single-layered structure, and the lower part 10X and the upper part 10Y thus have no physical interface at the border therebetween.

Here, details of the average fiber diameter AD are as described below.

The carbon fiber parts 1 have the average fiber diameter AD as described above, and the negative electrode 10 includes the lower part 10X and the upper part 10Y as illustrated in FIG. 3. The carbon fiber parts 1 in the lower part 10X thus have an average fiber diameter ADX, and the carbon fiber parts 1 in the upper part 10Y thus have an average fiber diameter ADY. The average fiber diameters ADX and ADY are thus different from each other.

A reason why the average fiber diameters ADX and ADY are different from each other is that this makes it easier for the electrode reactant to move via the voids 10G upon the electrode reaction, and also makes it easier for the electrode reaction to proceed smoothly even if the electrode reaction repeatedly occurs. In this case, it is easier for the electrode reactant to move smoothly even if a current value at the time of the electrode reaction increases, in particular.

A procedure for calculating the average fiber diameter ADX is as described below. First, the negative electrode 10 is collected, following which the negative electrode 10 is washed with a washing solvent such as dimethyl carbonate. Note that when a secondary battery including the negative electrode 10 has been acquired, the negative electrode 10 is collected by disassembling the secondary battery. Thereafter, the negative electrode 10 is cut by means of, for example, an ion milling apparatus to thereby cause a section of the negative electrode 10 to be exposed.

Thereafter, the section of the lower part 10X is observed by means of a scanning electron microscope (SEM) or a transmission electron microscope (TEM) to thereby acquire a result of observation (an observation image) of the section. The carbon fiber parts 1 are thus identifiable in the observation image. Observation conditions including, without limitation, an acceleration voltage and a magnification may be set as desired.

Thereafter, any fifty carbon fiber parts 1 are selected, following which the respective fiber diameters D of the fifty carbon fiber parts 1 are measured. Lastly, an average value of the fifty fiber diameters D is calculated as the average fiber diameter ADX.

Note that a procedure for calculating the average fiber diameter ADY is similar to the procedure for calculating the average fiber diameter ADX described above, except that a section of the upper part 10Y is observed instead of the section of the lower part 10X.

The average fiber diameter ADX may be greater than the average fiber diameter ADY, or may be less than the average fiber diameter ADY.

Here, a definition of a case where the average fiber diameter ADX is greater than the average fiber diameter ADY is as described below.

That the average fiber diameter ADX is greater than the average fiber diameter ADY refers to that, when ten average fiber diameters ADX and ten average fiber diameters ADY are each calculated, every one of the ten average fiber diameters ADX is greater than each of the ten average fiber diameters ADY. Thus, a minimum value of the ten average fiber diameters ADX is greater than a maximum value of the ten average fiber diameters ADY. In other words, when any one of the ten average fiber diameters ADX is less than any one of the ten average fiber diameters ADY, it is not possible to say that the average fiber diameter ADX is greater than the average fiber diameter ADY.

A reason why it is defined that the average fiber diameter ADX is greater than the average fiber diameter ADY when every one of the ten average fiber diameters ADX is greater than each of the ten average fiber diameters ADY is to positively exclude a configuration in which the average fiber diameter ADX accidentally becomes greater than the average fiber diameter ADY due to, for example, a cause in manufacturing of the negative electrode 10.

In other words, it is not possible to say that the average fiber diameter ADX is greater than the average fiber diameter ADY when, although the average fiber diameter ADX calculated for any one location in the lower part 10X is greater than the average fiber diameter ADY calculated for any one location in the upper part 10Y, the average fiber diameter ADX calculated for another location in the lower part 10X is less than the average fiber diameter ADY calculated for another location in the upper part 10Y.

In contrast, it is possible to say that the average fiber diameter ADX is greater than the average fiber diameter ADY when the average fiber diameter ADX is greater than the average fiber diameter ADY regardless of location in the lower part 10X for which the average fiber diameter ADX is calculated and regardless of location in the upper part 10Y for which the average fiber diameter ADY is calculated.

Note that a definition of a case where the average fiber diameter ADX is less than the average fiber diameter ADY is similar to the above-described definition of the case where the average fiber diameter ADX is greater than the average fiber diameter ADY, except that the magnitude relationship is the opposite.

That is, that the average fiber diameter ADX is less than the average fiber diameter ADY refers to that, when ten average fiber diameters ADX and ten average fiber diameters ADY are each calculated, every one of the ten average fiber diameters ADX is less than each of the ten average fiber diameters ADY. Thus, a maximum value of the ten average fiber diameters ADX is less than a minimum value of the ten average fiber diameters ADY.

A reason why it is defined that the average fiber diameter ADX is less than the average fiber diameter ADY when every one of the ten average fiber diameters ADX is less than each of the ten average fiber diameters ADY is to positively exclude a configuration in which the average fiber diameter ADX accidentally becomes less than the average fiber diameter ADY due to, for example, a cause in manufacturing of the negative electrode 10.

As will be described later, when the negative electrode 10 is used together with a positive electrode and a separator in the secondary battery, the separator is disposed between the negative electrode 10 and the positive electrode. The negative electrode 10 and the positive electrode are thus opposed to each other with the separator interposed therebetween.

In this case, the negative electrode 10 being bisected into the lower part 10X and the upper part 10Y in the thickness direction H is equivalent to the negative electrode 10 being bisected in a direction in which the positive electrode and the negative electrode 10 are opposed to each other with the separator interposed therebetween. Thus, in the negative electrode 10, the lower part 10X is positioned on a side close to the separator, and the upper part 10Y is positioned on a side far from the separator.

In particular, it is preferable that the average fiber diameter AD be less in the lower part 10X than in the upper part 10Y, and the average fiber diameter ADX be thus less than the average fiber diameter ADY. A reason for this is that this makes it further easier for the electrode reactant to move, and also makes it further easier for the electrode reaction to proceed smoothly even if the electrode reaction repeatedly occurs.

As long as the average fiber diameter ADX is less than the average fiber diameter ADY, a ratio of the average fiber diameter ADX to the average fiber diameter ADY (=ADX/ADY) is not particularly limited. However, the average fiber diameter ADX is preferably within a range from 0.0003 times the average fiber diameter ADY to 0.5 times the average fiber diameter ADY both inclusive, in particular. A reason for this is that in such a case, the average fiber diameter ADX and the average fiber diameter ADY are different from each other sufficiently greatly, which makes it sufficiently easier for the electrode reactant to move, and also makes it sufficiently easier for the electrode reaction to proceed even if the electrode reaction repeatedly occurs.

The average fiber diameter AD in the whole of the negative electrode 10 is not particularly limited, but is preferably within a range from 10 nm to 12000 nm both inclusive, in particular. A reason for this is that this allows the carbon fiber parts 1 constituting a main part of the negative electrode 10 to be sufficiently great in the fiber diameter D. As a result, a sufficient electrically conductive network (three-dimensional mesh structure) is formed inside the negative electrode 10, which improves the electrical conductivity of the negative electrode 10.

Note that as long as the average fiber diameters ADX and ADY are different from each other, each of the average fiber diameters ADX and ADY is not particularly limited. When the average fiber diameter ADX is less than the average fiber diameter ADY, in particular, the average fiber diameter ADX is preferably within a range from 5 nm to 8000 nm both inclusive, and the average fiber diameter ADY is preferably within a range from 100 nm to 16000 nm both inclusive. A reason for this is that in such a case, the average fiber diameters ADX and ADY are different from each other sufficiently greatly, which makes it sufficiently easier for the electrode reactant to move, and also makes it sufficiently easier for the electrode reaction to proceed even if the electrode reaction repeatedly occurs.

Details of the weight proportion MA are as described below.

The negative electrode 10 has the weight proportion MA as described above, and includes the lower part 10X and the upper part TOY as illustrated in FIG. 3. The lower part 10X thus has a weight proportion MAX, and the upper part TOY thus has a weight proportion MAY. The weight proportions MAX and MAY are thus different from each other.

A reason why the weight proportions MAX and MAY are different from each other is that this facilitates insertion and extraction of the electrode reactant into and from a silicon component (the covering parts 2) upon the electrode reaction, while suppressing expansion and contraction of the negative electrode 10 owing to a carbon component (the carbon fiber parts 1) upon the electrode reaction.

A procedure for calculating the weight proportion MAX is as described below. First, the negative electrode 10 is collected, following which the negative electrode 10 is washed with a washing solvent such as dimethyl carbonate. Thereafter, a sample for analysis is acquired by taking a sample of the lower part 10X from the negative electrode 10. Thereafter, the sample is analyzed by thermogravimetry-differential thermal analysis (TG-DTA) to thereby determine the weights M1 and M2. Note that any TG-DTA apparatus may be used to analyze the sample.

In the analysis of the lower part 10X, a weight loss that results when a heating temperature is increased to about 450° C. corresponds to a weight of the electrolytic solution, the binder, etc., and a weight loss that results when the heating temperature is increased to a range of about 450° C. to about 1350° C. corresponds to a weight of the carbon component, i.e., the weight M1 of the carbon fiber parts 1. As a result, a weight of the remaining component corresponds to a weight of the silicon component, i.e., the weight M2 of the covering parts 2.

Note that the above-described temperature (i.e., about 450° C.) at which the weight loss related to the electrolytic solution, etc. is detectable can vary depending on the kind of the binder. Specifically, when the binder is polyvinylidene difluoride, its extinction temperature is about 460° C., assuming that a local minimum of a differential curve of the DTA corresponds to the extinction temperature.

Lastly, the weight proportion MAX is calculated based on the foregoing calculation expression using the weights M1 and M2.

Note that a procedure for calculating the weight proportion MAY is similar to the procedure for calculating the weight proportion MAX described above, except that the upper part 10Y is analyzed instead of the lower part 10X.

The weight proportion MAX may be greater than the weight proportion MAY, or may be less than the weight proportion MAY. A definition of a magnitude relationship between the weight proportions MAX and MAY is similar to the definition of the magnitude relationship between the average fiber diameters ADX and ADY described above.

Specifically, that the weight proportion MAX is greater than the weight proportion MAY refers to that, when ten weight proportions MAX and ten weight proportions MAY are each calculated, every one of the ten weight proportions MAX is greater than each of the ten weight proportions MAY. Thus, a minimum value of the ten weight proportions MAX is greater than a maximum value of the ten weight proportions MAY.

A reason why it is defined that the weight proportion MAX is greater than the weight proportion MAY when every one of the ten weight proportions MAX is greater than each of the ten weight proportions MAY is to positively exclude a configuration in which the weight proportion MAX accidentally becomes greater than the weight proportion MAY due to, for example, a cause in manufacturing of the negative electrode 10.

Note that a definition of a case where the weight proportion MAX is less than the weight proportion MAY is similar to the above-described definition of the case where the weight proportion MAX is greater than the weight proportion MAY, except that the magnitude relationship is the opposite.

That is, that the weight proportion MAX is less than the weight proportion MAY refers to that, when ten weight proportions MAX and ten weight proportions MAY are each calculated, every one of the ten weight proportions MAX is less than each of the ten weight proportions MAY. Thus, a maximum value of the ten weight proportions MAX is less than a minimum value of the ten weight proportions MAY.

A reason why it is defined that the weight proportion MAX is less than the weight proportion MAY when every one of the ten weight proportions MAX is less than each of the ten weight proportions MAY is to positively exclude a configuration in which the weight proportion MAX accidentally becomes less than the weight proportion MAY due to, for example, a cause in manufacturing of the negative electrode 10.

As described above, when the negative electrode 10 and the positive electrode are opposed to each other with the separator interposed therebetween in the secondary battery, in particular, it is preferable that the weight proportion MA be greater in the lower part 10X than in the upper part 10Y, and the weight proportion MAX be thus greater than the weight proportion MAY. A reason for this is that this further facilitates the insertion and extraction of the electrode reactant while further suppressing the expansion and contraction of the negative electrode 10.

As long as the weight proportion MAX is greater than the weight proportion MAY, a ratio of the weight proportion MAX to the weight proportion MAY (=MAX/MAY) is not particularly limited. However, the weight proportion MAX is preferably within a range from 1.04 times the weight proportion MAY to 4.65 times the weight proportion MAY both inclusive, in particular. A reason for this is that in such a case, the weight proportions MAX and MAY are different from each other sufficiently greatly, which sufficiently facilitates the insertion and extraction of the electrode reactant, while sufficiently suppressing the expansion and contraction of the negative electrode 10.

The weight proportion MA in the whole of the negative electrode 10 is not particularly limited, but is preferably within a range from 40 wt % to 80 wt % both inclusive, in particular. A reason for this is that this sufficiently facilitates the insertion and extraction of the electrode reactant, while sufficiently suppressing the expansion and contraction of the negative electrode 10.

Note that as long as the weight proportions MAX and MAY are different from each other, each of the weight proportions MAX and MAY is not particularly limited. When the weight proportion MAX is greater than the weight proportion MAY, in particular, the weight proportion MAX is preferably within a range from 42 wt % to 88 wt % both inclusive, and the weight proportion MAY is preferably within a range from 12 wt % to 78 wt % both inclusive. A reason for this is that in such a case, the weight proportions MAX and MAY are different from each other sufficiently greatly, which sufficiently facilitates the insertion and extraction of the electrode reactant, while sufficiently suppressing the expansion and contraction of the negative electrode 10.

Details of the void rate R are as described below.

The negative electrode 10 has the void rate R as described above, and includes the lower part 10X and the upper part 10Y as illustrated in FIG. 3. The lower part 10X thus has a void rate RX, and the upper part 10Y thus has a void rate 10RY. The void rates RX and RY are thus different from each other.

A reason why the void rates RX and RY are different from each other is that this makes it easier for the electrode reactant to move by using distribution of the voids 10G upon the electrode reaction, and also makes it easier for the electrode reaction to proceed smoothly even if the electrode reaction repeatedly occurs. In this case, it is easier for the electrode reactant to move smoothly even if the current value at the time of the electrode reaction increases, in particular.

A procedure for calculating the void rate RX is as described below. By a procedure similar to the above-described procedure in calculating the average fiber diameter ADX, the negative electrode 10 is collected and washed, following which a three-dimensional image of the lower part 10X is acquired by means of a focused ion beam scanning electron microscope (FIB-SEM) to thereby calculate the void rate RX based on the three-dimensional image by image analysis processing. Usable in the image analysis processing is, for example, GeoDict, comprehensive package software for innovative material development available from Math2Market GmbH.

Note that a procedure for calculating the void rate RY is similar to the procedure for calculating the void rate RX described above, except that a three-dimensional image of the upper part 10Y is acquired instead of that of the lower part 10X.

The void rate RX may be greater than the void rate RY, or may be less than the void rate RY. A definition of a magnitude relationship between the void rates RX and RY is similar to the above-described definition of the magnitude relationship between the average fiber diameters ADX and ADY.

Specifically, that the void rate RX is greater than the void rate RY refers to that, when ten void rates RX and ten void rates RY are each calculated, every one of the ten void rates RX is greater than each of the ten void rates RY. Thus, a minimum value of the ten void rates RX is greater than a maximum value of the ten void rates RY.

A reason why it is defined that the void rate RX is greater than the void rate RY when every one of the ten void rates RX is greater than each of the ten void rates RY is to positively exclude a configuration in which the void rate RX accidentally becomes greater than the void rate RY due to, for example, a cause in manufacturing of the negative electrode 10.

Note that a definition of a case where the void rate RX is less than the void rate RY is similar to the above-described definition of the case where the void rate RX is greater than the void rate RY, except that the magnitude relationship is the opposite.

That is, that the void rate RX is less than the void rate RY refers to that, when ten void rates RX and ten void rates RY are each calculated, every one of the ten void rates RX is less than each of the ten void rates RY. Thus, a maximum value of the ten void rates RX is less than a minimum value of the ten void rates RY.

A reason why it is defined that the void rate RX is less than the void rate RY when every one of the ten void rates RX is less than each of the ten void rates RY is to positively exclude a configuration in which the void rate RX accidentally becomes less than the void rate RY due to, for example, a cause in manufacturing of the negative electrode 10.

As described above, when the negative electrode 10 and the positive electrode are opposed to each other with the separator interposed therebetween in the secondary battery, it is preferable that the void rate R be greater in the upper part 10Y than in the lower part 10X, and the void rate RY be thus greater than the void rate RX, in particular. A reason for this is that this makes it further easier for the electrode reactant to move, and also makes it further easier for the electrode reaction to proceed smoothly even if the electrode reaction repeatedly occurs.

As long as the void rate RY is greater than the void rate RX, a ratio of the void rate RY to the void rate RX (=RY/RX) is not particularly limited. However, the void rate RY is preferably within a range from 1.1 times the void rate RX to 4.5 times the void rate RX both inclusive, in particular. A reason for this is that in such a case, the void rates RX and RY are different from each other sufficiently greatly, which makes it sufficiently easier for the electrode reactant to move, and also makes it sufficiently easier for the electrode reaction to proceed even if the electrode reaction repeatedly occurs.

The void rate R in the whole of the negative electrode 10 is not particularly limited, but is preferably within a range from 40 vol % to 70 vol % both inclusive, in particular. A reason for this is that this makes it sufficiently easier for the electrode reactant to move, and also makes it sufficiently easier for the electrode reaction to proceed even if the electrode reaction repeatedly occurs.

Note that as long as the void rates RX and RY are different from each other, each of the void rates RX and RY is not particularly limited. When the void rate RY is greater than the void rate RX in particular, the void rate RX is preferably within a range from 20 vol % to 67 vol % both inclusive, and the void rate RY is preferably within a range from 42 vol % to 90 vol % both inclusive. A reason for this is that in such a case, the void rates RX and RY are different from each other sufficiently greatly, which makes it sufficiently easier for the electrode reactant to move, and also makes it sufficiently easier for the electrode reaction to proceed even if the electrode reaction repeatedly occurs.

As described above, one or more of the average fiber diameter AD, the weight proportion MA, or the void rate R vary between the lower part 10X and the upper part 10Y. In addition, although not described in detail here, an average fiber length, an average curvature, or both may vary between the lower part 10X and the upper part 10Y.

The average fiber length is an average value of fiber lengths of the respective carbon fiber parts 1. The average curvature is an average value of curvatures of the respective carbon fiber parts 1.

The covering parts 2 have an average thickness AT1. The average thickness AT1 is not particularly limited, but is preferably within a range from 1 nm to 3000 nm both inclusive, in particular. A reason for this is that this allows the covering parts 2 to cover the surfaces of the carbon fiber parts 1 by sufficiently great amounts, making it possible to obtain a sufficient energy density at the negative electrode 10 while ensuring the electrical conductivity of the negative electrode 10.

A procedure for calculating the average thickness AT1 is as described below. First, an observation result (an observation image) of a section of the negative electrode 10 is acquired by a procedure similar to the above-described procedure used when calculating the average fiber diameter ADX. Thereafter, any twenty covering parts 2 are selected, following which the thicknesses T1 of the respective twenty covering parts 2 are measured. Note that when the thickness T1 of a single covering part 2 varies between locations, a maximum value of the thicknesses T1 is used. Lastly, an average value of the twenty thicknesses T1 is calculated as the average thickness AT1.

The negative electrode 10 is manufactured by a procedure described below.

A manufacturing procedure in a case where the average fiber diameter AD, the weight proportion MA, and the void rate R are each varied discontinuously in the thickness direction H is as described below. Described here is a case where each of the average fiber diameter AD, the weight proportion MA, and the void rate R is caused to vary between the lower part 10X and the upper part 10Y.

First, prepared are multiple fibrous carbon materials having the average fiber diameter ADX that are the materials to be included in the lower part 10X. Details of the fibrous carbon materials are as described above.

Thereafter, the silicon-containing material is deposited onto the surface of each of the fibrous carbon materials by a vapor-phase method. The vapor-phase method is not particularly limited in kind, and specifically, any one or more kinds of vapor-phase methods including, without limitation, a vacuum deposition method, a chemical vapor deposition (CVD) method, and a sputtering method are usable. The covering part 2 is thereby formed on the surface of each of the fibrous carbon materials. Thus, the surface of each of the fibrous carbon materials is covered with the covering part 2 (the weight proportion MAX).

Thereafter, prepared are multiple fibrous carbon materials having the average fiber diameter ADY that are the materials to be included in the upper part 10Y.

Thereafter, by a similar procedure, the covering part 2 is formed on the surface of each of the fibrous carbon materials by depositing the silicon-containing material on the surface of each of the fibrous carbon materials (the weight proportion MAY).

In this manner, the two kinds of multiple fibrous carbon materials to be used to form the lower part 10X and the upper part 10Y are obtained.

Thereafter, the fibrous carbon materials (having the average fiber diameter ADX and the weight proportion MAX) on which the covering parts 2 are formed, and the fibrous carbon materials (having the average fiber diameter ADY and the weight proportion MAY) on which the covering parts 2 are formed are combined with each other by using an apparatus for combining multiple layers of paper sheets.

In this case, the three-dimensional mesh structure having the voids 10G is formed by the former fibrous carbon materials, and therefore, the lower part 10X (having the void rate RX) including the carbon fiber parts 1 and the covering parts 2 is formed. In addition, the three-dimensional mesh structure having the voids 10G is formed by the latter fibrous carbon materials, and therefore, the upper part 10Y (having the void rate RY) including the carbon fiber parts 1 and the covering parts 2 is formed. Thus, the lower part 10X and the upper part 10Y are stacked on each other, and the lower part 10X and the upper part 10Y are coupled to each other.

As a result, the negative electrode 10 is assembled. The negative electrode 10 includes the lower part 10X and the upper part 10Y that are physically separated from each other, and thus has the two-layered structure.

Lastly, on an as-needed basis, the negative electrode 10 is pressed by means of, for example, a pressing machine, following which the negative electrode 10 is subjected to firing. In this case, the void rates RX and RY are each adjustable by changing pressure applied in pressing. A firing temperature may be set as desired.

The negative electrode 10 including the carbon fiber parts 1 and the covering parts 2, and having the voids 10G is thus completed. In this case, the average fiber diameter AD, the weight proportion MA, and the void rate R are adjustable based on the average fiber diameters ADX and ADY, the weight proportions MAX and MAY, and the void rates RX and RY, respectively.

A manufacturing procedure in a case where the average fiber diameter AD, the weight proportion MA, and the void rate R are each varied continuously in the thickness direction H is as described below. Described here is a case where each of the weight proportion MA and the void rate R is caused to vary between the lower part 10X and the upper part 10Y.

First, as described above, the carbon paper that includes the carbon fiber parts 1 is prepared.

Thereafter, powder of the silicon-containing material is put into a solvent. The powder of the silicon-containing material is thus dispersed in the solvent to result in a dispersion liquid. The solvent may be an aqueous solvent or a nonaqueous solvent (an organic solvent). In this case, a binder may be added to the solvent. Details of the binder are as described above.

Thereafter, the dispersion liquid is applied on the carbon fiber parts 1, following which the applied dispersion liquid is dried. The dispersion liquid including the powder of the silicon-containing material thus permeates into the carbon fiber parts 1, causing the powder of the silicon-containing material to be fixed onto the surface of each of the carbon fiber parts 1. Thus, the surface of each of the carbon fiber parts 1 is covered with the powder of the silicon-containing material, and the covering parts 2 are thereby formed. Note that the carbon fiber parts 1 may be immersed in the dispersion liquid, instead of applying the dispersion liquid on the carbon fiber parts 1.

In this case, when the dispersion liquid is caused to permeate into the carbon fiber parts 1, as a distance (a depth) to the carbon fiber parts 1 into which the dispersion liquid permeates is greater, an amount of the dispersion liquid permeating into the carbon fiber parts 1 decreases, and therefore, an amount of the powder of the silicon-containing material fixed onto the surface of each of the carbon fiber parts 1 decreases.

In such a manner, the average fiber diameter AD, the weight proportion MA, and the void rate R each vary continuously in the thickness direction H. The negative electrode 10 including the lower part 10X and the upper part TOY is thus assembled. The negative electrode 10 includes the lower part 10X and the upper part TOY that are physically integrated with each other, and thus has the single-layered structure. Note that the average fiber diameter ADX, the weight proportion MAX, and the void rate RX are different from the average fiber diameter ADY, the weight proportion MAY, and the void rate RY, respectively.

In this case, the weight proportions MAX and MAY are each adjustable by changing, for example, a concentration of the dispersion liquid, a permeating speed of the dispersion liquid, and a drying condition of the dispersion liquid. The void rates RX and RY are each adjustable by changing, for example, the concentration of the dispersion liquid, the permeating speed of the dispersion liquid, and the drying condition of the dispersion liquid, together with the void rate R in an initial phase.

Note that when causing the dispersion liquid to permeate into the carbon fiber parts 1, the dispersion liquid may be sucked by means of, for example, a suction apparatus, from a side opposite to a side from which the dispersion liquid permeates into the carbon fiber parts 1. This makes it easier for the dispersion liquid to permeate into the carbon fiber parts 1, making it easier for the covering parts 2 to be formed. In this case, the weight proportions MAX and MAY are each adjustable by changing, for example, a suction condition.

Lastly, on an as-needed basis, the negative electrode 10 is pressed by means of, for example, a pressing machine, following which the negative electrode 10 is subjected to firing. In this case, the void rates RX and RY are each adjustable by changing pressure applied in pressing. A firing temperature may be set as desired.

The negative electrode 10 including the carbon fiber parts 1 and the covering parts 2, and having the voids 10G is thus completed. In this case, the average fiber diameter AD, the weight proportion MA, and the void rate R are adjustable based on the average fiber diameters ADX and ADY, the weight proportions MAX and MAY, and the void rates RX and RY, respectively.

The negative electrode 10 includes the carbon fiber parts 10 and the covering parts 2 described above, and has the voids 10G. In the negative electrode 10, one or more of the average fiber diameter AD, the weight proportion MA, or the void rate R vary between the lower part 10X and the upper part 10Y.

In this case, as described above, the following series of kinds of action are obtainable by using a difference between the physical property of the lower part 10X and the physical property of the upper part 10Y.

Firstly, inside the negative electrode 10, the electrically conductive network (the three-dimensional mesh structure) is formed by the carbon fiber parts 1 that include the carbon-containing material having electrical conductivity. Accordingly, the electrical conductivity is improved.

Secondly, the covering parts 2 each include the silicon-containing material that is superior in electrode-reactant insertability and electrode-reactant extractability. Accordingly, a high energy density is obtainable.

Thirdly, the voids 10G different from each other in inner diameter are provided inside the negative electrode 10. Accordingly, it is easier for the electrode reactant to move via the voids 10G upon the electrode reaction, and it is also easier for the electrode reaction to proceed smoothly even if the electrode reaction repeatedly occurs. In this case, although a movement speed of the electrode reactant tends to be limited in the upper part 10Y positioned on the side far from the separator in the secondary battery, it is easier for the electrode reactant to move smoothly even if the current value at the time of the electrode reaction increases.

Fourthly, the voids 10G having respective inner diameters that are discontinuous in size are distributed inside the negative electrode 10. Accordingly, it is further easier for the electrode reactant to move upon the electrode reaction, and it is also further easier for the electrode reaction to proceed smoothly even if the electrode reaction repeatedly occurs.

As described above, while a high energy density is obtainable, it is markedly easier for the electrode reactant to move upon the electrode reaction, and it is also markedly easier for the electrode reaction to proceed smoothly even if the electrode reaction repeatedly occurs. Accordingly, it is possible for a secondary battery including the negative electrode 10 to achieve a superior initial capacity characteristic, a superior load characteristic, and a superior cyclability characteristic.

Note that because it is unnecessary to provide the metal current collector in the negative electrode 10 described above, it is possible for the negative electrode 10 to achieve a reduction in weight and an increase in gravimetric energy density (Wh/kg), as compared with when the negative electrode 10 includes the metal current collector.

In particular, the average fiber diameter ADX may be less than the average fiber diameter ADY. This makes it easier for the carbon fiber parts 1 having a relatively small fiber diameter AD to be disposed in the vicinity of the covering parts 2 (the silicon-containing material) in the lower part 10X positioned on the side close to the separator in the secondary battery. This makes it easier for an electronic contact defect to be solved inside the negative electrode 10 upon the electrode reaction. This makes it further easier for the electrode reactant to move upon the electrode reaction, and also makes it further easier for the electrode reaction to proceed smoothly even if the electrode reaction repeatedly occurs. It is thus possible to achieve higher effects. In this case, the average fiber diameter ADX may be within the range from 0.0003 times the average fiber diameter ADY to 0.5 times the average fiber diameter ADX both inclusive. This makes it sufficiently easier for the electrode reactant to move, and also makes it sufficiently easier for the electrode reaction to proceed even if the electrode reaction repeatedly occurs. It is thus possible to achieve further higher effects.

Further, the weight proportion MAX may be greater than the weight proportion MAY. This further facilitates the insertion and extraction of the electrode reactant while further suppressing the expansion and contraction of the negative electrode 10. It is thus possible to achieve higher effects. In this case, the weight proportion MAX may be within the range from 1.04 times the weight proportion MAY to 4.65 times the weight proportion MAY both inclusive. This sufficiently facilitates the insertion and extraction of the electrode reactant while sufficiently suppressing the expansion and contraction of the negative electrode 10. It is thus possible to achieve further higher effects.

Further, the void rate RY may be greater than the void rate RX. This makes it further easier for the electrode reactant to move, and also makes it further easier for the electrode reaction to proceed smoothly even if the electrode reaction repeatedly occurs. It is thus possible to achieve higher effects. In this case, the void rate RY may be within the range from 1.1 times the void rate RX to 4.5 times the void rate RX both inclusive. This makes it sufficiently easier for the electrode reactant to move, and also makes it sufficiently easier for the electrode reaction to proceed even if the electrode reaction repeatedly occurs. It is thus possible to achieve further higher effects.

Further, the average fiber diameter AD in the whole of the negative electrode 10 may be within the range from 10 nm to 12000 nm both inclusive, the weight proportion MA in the whole of the negative electrode 10 may be within the range from 40 wt % to 80 wt % both inclusive, and the void rate R in the whole of the negative electrode 10 may be within the range from 40 vol % to 70 vol % both inclusive. This makes it sufficiently easier for the electrode reactant to move, and also makes it sufficiently easier for the electrode reaction to proceed even if the electrode reaction repeatedly occurs, while sufficiently suppressing the expansion and contraction of the negative electrode 10. It is thus possible to achieve further higher effects.

Further, the content of silicon in each of the covering parts 2 (the silicon-containing material) may be greater than or equal to 80 wt %. In such a case, a markedly high energy density is obtainable while the electrical conductivity is ensured. It is thus possible to achieve higher effects.

Next, a description is given of a secondary battery according to an embodiment of the technology and, more specifically, of an example secondary battery that includes the negative electrode 10 described above.

As described above, the secondary battery to be described here is a secondary battery that obtains a battery capacity using insertion and extraction of an electrode reactant, and includes a positive electrode, a negative electrode, a separator, and an electrolytic solution. The electrolytic solution is a liquid electrolyte. The electrode reactant is not particularly limited in kind, as described above.

Examples are given below of a case where the electrode reactant is lithium. A secondary battery that obtains a battery capacity using insertion and extraction of lithium is what is called a lithium-ion secondary battery. In the lithium-ion secondary battery, lithium is inserted and extracted in an ionic state.

In this case, a charge capacity of the negative electrode is greater than a discharge capacity of the positive electrode. In other words, an electrochemical capacity per unit area of the negative electrode is set to be greater than an electrochemical capacity per unit area of the positive electrode. A reason for this is to prevent precipitation of the electrode reactant on a surface of the negative electrode during charging.

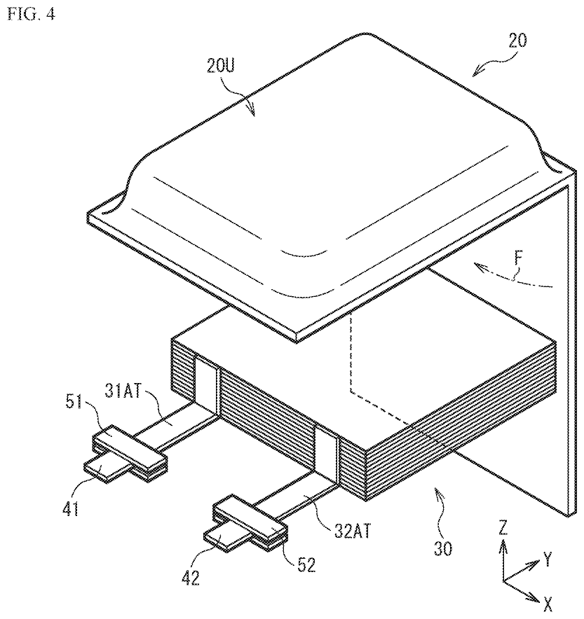

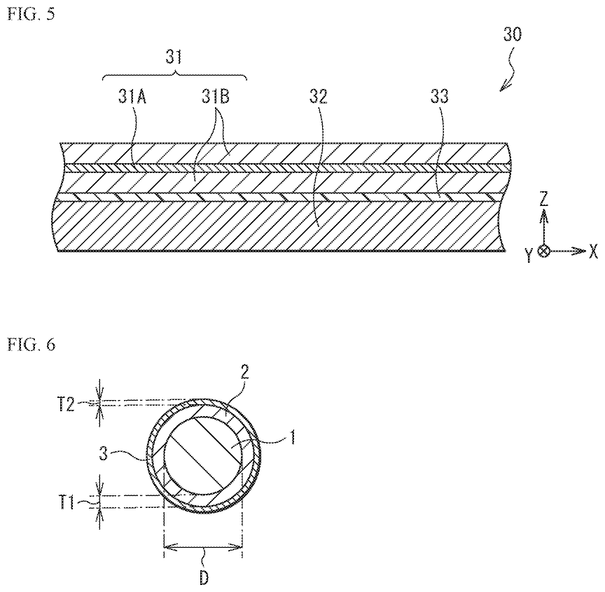

FIG. 4 illustrates a perspective configuration of the secondary battery. FIG. 5 illustrates an enlarged sectional configuration of a battery device 30 illustrated in FIG. 4. Note that FIG. 4 illustrates a state where an outer package film 20 and the battery device 30 are separated from each other, and FIG. 5 illustrates only a portion of the battery device 30. In the following description, reference will be made as necessary to FIGS. 1 to 3 described already above, and also to the components of the negative electrode 10 described already above.

As illustrated in FIGS. 4 and 5, the secondary battery includes the outer package film 20, the battery device 30, a positive electrode lead 41, a negative electrode lead 42, and sealing films 51 and 52. The secondary battery described here is a secondary battery of a laminated-film type in which the outer package film 20 having flexibility or softness is used.

As illustrated in FIG. 4, the outer package film 20 is a flexible outer package member that contains the battery device 30. The outer package film 20 has a pouch-shaped structure that is sealed in a state where the battery device 30 is contained inside the outer package film 20. The outer package film 20 thus contains a positive electrode 31 and a negative electrode 32 to be described later, and also contains the electrolytic solution.

Here, the outer package film 20 is a single film-shaped member, and is folded in a folding direction F. The outer package film 20 has a depression part 20U to place the battery device 30 therein. The depression part 20U is what is called a deep drawn part.

Specifically, the outer package film 20 is a three-layered laminated film including a fusion-bonding layer, a metal layer, and a surface protective layer that are stacked in this order from an inner side. In a state where the outer package film 20 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers.

As illustrated in FIGS. 4 and 5, the battery device 30 is a power generation device that includes the positive electrode 31, the negative electrode 32, a separator 33, and the electrolytic solution (not illustrated). The battery device 30 is contained inside the outer package film 20.

The battery device 30 is what is called a stacked electrode body. The positive electrode 31 and the negative electrode 32 are thus stacked on each other with the separator 33 interposed therebetween. The respective numbers of the positive electrodes 31, the negative electrodes 32, and the separators 33 to be stacked are not particularly limited. Here, multiple positive electrodes 31 and multiple negative electrodes 32 are alternately stacked with the separators 33 each interposed between corresponding one of the positive electrodes 31 and corresponding one of the negative electrodes 32.

As illustrated in FIG. 5, the positive electrode 31 includes a positive electrode current collector 31A and a positive electrode active material layer 31B.

The positive electrode current collector 31A has two opposed surfaces on each of which the positive electrode active material layer 31B is to be provided. The positive electrode current collector 31A includes an electrically conductive material such as a metal material. Specific examples of the metal material include aluminum.

Note that as illustrated in FIG. 4, the positive electrode current collector 31A includes a protruding part 31AT without the positive electrode active material layer 31B provided thereon. Multiple protruding parts 31AT are joined to each other into a single lead form. Here, the protruding part 31AT is integrated with a portion of the positive electrode current collector 31A other than the protruding part 31AT. However, the protruding part 31AT may be provided separately from the portion of the positive electrode current collector 31A other than the protruding part 31AT, and may thus be joined to the portion of the positive electrode current collector 31A other than the protruding part 31AT.

The positive electrode active material layer 31B includes any one or more of positive electrode active materials into which lithium is insertable and from which lithium is extractable. Note that the positive electrode active material layer 31B may further include any one or more of other materials including, without limitation, a positive electrode binder and a positive electrode conductor.

Here, the positive electrode active material layer 31B is provided on each of the two opposed surfaces of the positive electrode current collector 31A. Note that the positive electrode active material layer 31B may be provided only on one of the two opposed surfaces of the positive electrode current collector 31A on a side where the positive electrode 31 is opposed to the negative electrode 32. A method of forming the positive electrode active material layer 31B is not particularly limited, and specifically, one or more of methods including, without limitation, a coating method, are usable.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are any of elements other than lithium and the transition metal elements, and are not particularly limited in kind. Specifically, the one or more other elements are any of elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material. Specific examples of the carbon material include graphite, carbon black, acetylene black, Ketjen black, and a carbon nanotube. Note that the electrically conductive material may be a metal material or a polymer compound, for example.

As illustrated in FIG. 5, the negative electrode 32 is opposed to the positive electrode 31 with the separator 33 interposed therebetween. Lithium is insertable into and extractable from the negative electrode 32. The negative electrode 32 has a configuration similar to the configuration of the negative electrode 10 (the lower part 10X and the upper part 10Y) described above. Thus, the negative electrode 32 includes the carbon fiber parts 1 and the covering parts 2, and has the voids 10G. As described above, the lower part 10X is positioned on a side closer to the separator 33 than the upper part 10Y, and the upper part 10Y is positioned on a side farther from the separator 33 than the lower part 10X.

In the negative electrode 32, lithium is inserted into and extracted from each of the covering parts 2 mainly. However, lithium may also be inserted into and extracted from the carbon fiber parts 1, as well as each of the covering parts 2.

Note that as illustrated in FIG. 4, the negative electrode 32 includes a protruding part 31AT that includes some of the carbon fiber parts 1 without the covering parts 2 provided thereon. Multiple protruding parts 31AT are joined to each other into a single lead form.

The separator 33 is an insulating porous film interposed between the positive electrode 31 and the negative electrode 32, as illustrated in FIG. 5. The separator 33 allows lithium ions to pass therethrough while preventing contact (a short circuit) between the positive electrode 31 and the negative electrode 32. The separator 33 includes a polymer compound such as polyethylene.

The electrolytic solution includes a solvent and an electrolyte salt. The positive electrode 31, the negative electrode 32, and the separator 33 are each impregnated with the electrolytic solution.

The solvent includes any one or more of nonaqueous solvents (organic solvents) including, without limitation, a carbonic-acid-ester-based compound, a carboxylic-acid-ester-based compound, and a lactone-based compound. The electrolytic solution including the nonaqueous solvent(s) is what is called a nonaqueous electrolytic solution.

The carbonic-acid-ester-based compound is, for example, a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include methyl acetate, ethyl acetate, methyl trimethylacetate, methyl propionate, ethyl propionate, and propyl propionate.

The lactone-based compound is, for example, a lactone. Specific examples of the lactone include γ-butyrolactone and γ-valerolactone.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium bis(fluorosulfonyl)imide (LiN(FSO₂)₂), lithium bis(trifluoromethanesulfonyl)imide (LiN(CF₃SO₂)₂), lithium bis(oxalato)borate (LiB(C₂O₄)₂), lithium difluoro(oxalato)borate (LiB(C₂O₄)F₂), lithium monofluorophosphate (Li₂PFO₃), and lithium difluorophosphate (LiPF₂O₂).

Although not particularly limited, a content of the electrolyte salt is specifically within a range from 0.3 mol/kg to 3.0 mol/kg both inclusive with respect to the solvent. A reason for this is that high ion conductivity is obtainable.

Note that the electrolytic solution may further include any one or more of additives. The additives are not particularly limited in kind, and specific examples thereof include an unsaturated cyclic carbonic acid ester, a halogenated carbonic acid ester, a phosphoric acid ester, an acid anhydride, a nitrile compound, and an isocyanate compound.

Specific examples of the unsaturated cyclic carbonic acid ester include vinylene carbonate, vinylethylene carbonate, and methylene ethylene carbonate. Specific examples of the halogenated carbonic acid ester include a halogenated cyclic carbonic acid ester and a halogenated chain carbonic acid ester. Specific examples of the halogenated cyclic carbonic acid ester include monofluoroethylene carbonate and difluoroethylene carbonate. Specific examples of the halogenated chain carbonic acid ester include fluoromethyl methyl carbonate. Specific examples of the phosphoric acid ester include trimethyl phosphate and triethyl phosphate.

The acid anhydride is a dicarboxylic acid anhydride, a disulfonic acid anhydride, or a carboxylic acid sulfonic acid anhydride, for example. Specific examples of the dicarboxylic acid anhydride include succinic anhydride. Specific examples of the disulfonic acid anhydride include ethanedisulfonic anhydride. Specific examples of the carboxylic acid sulfonic acid anhydride include sulfobenzoic anhydride.

The nitrile compound is a mononitrile compound, a dinitrile compound, or a trinitrile compound, for example. Specific examples of the mononitrile compound include acetonitrile. Specific examples of the dinitrile compound include succinonitrile. Specific examples of the trinitrile compound include 1,2,3-propanetricarbonitrile. Specific examples of the isocyanate compound include hexamethylene diisocyanate.

As illustrated in FIG. 4, the positive electrode lead 41 is a positive electrode terminal coupled to a joined body of the protruding parts 31AT of the positive electrodes 31, and is led from an inside to an outside of the outer package film 20. The positive electrode lead 41 includes an electrically conductive material such as a metal material. Specific examples of the metal material include aluminum. The positive electrode lead 41 is not particularly limited in shape, and specifically has any of shapes including, without limitation, a thin plate shape and a meshed shape.

As illustrated in FIG. 4, the negative electrode lead 42 is a negative electrode terminal coupled to a joined body of the protruding parts 32AT of the negative electrodes 32, and is led from the inside to the outside of the outer package film 20. The negative electrode lead 42 is preferably coupled to the carbon fiber parts 1 of the negative electrode 32, in particular. A reason for this is that an improved electrical continuity characteristic is achievable between the negative electrode 32 and the negative electrode lead 42. The negative electrode lead 42 includes an electrically conductive material such as a metal material. Specific examples of the metal material include copper. Here, the negative electrode lead 42 is led out in a direction similar to that in which the positive electrode lead 41 is led out. Details of a shape of the negative electrode lead 42 are similar to the details of the shape of the positive electrode lead 41.

The sealing film 51 is interposed between the outer package film 20 and the positive electrode lead 41. The sealing film 52 is interposed between the outer package film 20 and the negative electrode lead 42. Note that the sealing film 51, the sealing film 52, or both may be omitted.

The sealing film 51 is a sealing member that prevents entry of, for example, outside air into the outer package film 20. Further, the sealing film 51 includes a polymer compound, such as a polyolefin, that has adherence to the positive electrode lead 41. Examples of the polyolefin include polypropylene.

The sealing film 52 has a configuration similar to the configuration of the sealing film 51 except that the sealing film 52 is a sealing member that has adherence to the negative electrode lead 42. That is, the sealing film 52 includes a polymer compound, such as a polyolefin, that has adherence to the negative electrode lead 42.

Upon charging the secondary battery, in the battery device 30, lithium is extracted from the positive electrode 31, and the extracted lithium is inserted into the negative electrode 32 via the electrolytic solution. Upon discharging the secondary battery, in the battery device 30, lithium is extracted from the negative electrode 32, and the extracted lithium is inserted into the positive electrode 31 via the electrolytic solution. Upon such charging and discharging, lithium is inserted and extracted in an ionic state.

When manufacturing the secondary battery, the positive electrode 31 and the negative electrode 32 are each fabricated and the electrolytic solution is prepared, following which the secondary battery is assembled and the assembled secondary battery is subjected to a stabilization process, in accordance with an example procedure described below.

First, a mixture in which the positive electrode active material, the positive electrode binder, and the positive electrode conductor are mixed with each other, i.e., a positive electrode mixture, is put into a solvent to thereby prepare a positive electrode mixture slurry in paste form. The solvent may be an aqueous solvent, or may be an organic solvent. Thereafter, the positive electrode mixture slurry is applied on the two opposed surfaces (excluding the protruding part 31AT) of the positive electrode current collector 31A including the protruding part 31AT to thereby form the positive electrode active material layers 31B. Lastly, the positive electrode active material layers 31B are compression-molded by means of, for example, a roll pressing machine. In this case, the positive electrode active material layers 31B may be heated. The positive electrode active material layers 31B may be compression-molded multiple times. In this manner, the positive electrode active material layers 31B are formed on the respective two opposed surfaces of the positive electrode current collector 31A. The positive electrode 31 is thus fabricated.

The negative electrode 32 including the protruding part 32AT is fabricated by a procedure similar to the fabrication procedure of the negative electrode 10 described above.

The electrolyte salt is put into the solvent. The electrolyte salt is thereby dispersed or dissolved in the solvent. The electrolytic solution is thus prepared.

First, the positive electrodes 31 and the negative electrodes 32 are alternately stacked with the separators 33 each interposed between corresponding one of the positive electrodes 31 and corresponding one of the negative electrodes 32 to thereby fabricate an unillustrated stacked body. The stacked body has a configuration similar to the configuration of the battery device 30 except that the positive electrodes 31, the negative electrodes 32, and the separators 33 are each unimpregnated with the electrolytic solution.

Thereafter, the protruding parts 31AT are joined to each other, and the protruding parts 32AT are joined to each other. Thereafter, the positive electrode lead 41 is joined to the joined body of the protruding parts 31AT, and the negative electrode lead 42 is coupled to the joined body of the protruding parts 32AT.

Thereafter, the stacked body is placed inside the depression part 20U, following which the outer package film 20 (the fusion-bonding layer/the metal layer/the surface protective layer) is folded to thereby cause portions of the outer package film 20 to be opposed to each other. Thereafter, outer edge parts of two sides of the outer package film 20 (the fusion-bonding layer) opposed to each other are bonded to each other by a method such as a thermal-fusion-bonding method. The stacked body is thus contained inside the outer package film 20 having a pouch shape.

Lastly, the electrolytic solution is injected into the outer package film 20 having the pouch shape, following which the outer edge parts of the remaining one side of the outer package film 20 (the fusion-bonding layer) are bonded to each other by a method such as a thermal-fusion-bonding method. In this case, the sealing film 51 is interposed between the outer package film 20 and the positive electrode lead 41, and the sealing film 52 is interposed between the outer package film 20 and the negative electrode lead 42.

The stacked body is thereby impregnated with the electrolytic solution. Thus, the battery device 30, i.e., the stacked electrode body, is fabricated. In this manner, the battery device 30 is sealed in the outer package film 20 having the pouch shape, and the secondary battery is thus assembled.

The assembled secondary battery is charged and discharged. Various conditions including, without limitation, an environment temperature, the number of times of charging and discharging (the number of cycles), and charging and discharging conditions may be set as desired. A film is thereby formed on a surface of each of the positive electrode 31 and the negative electrode 32. This brings the secondary battery into an electrochemically stable state. The secondary battery is thus completed.

According to the secondary battery, the negative electrode 32 has the configuration similar to the configuration of the negative electrode 10 described above. Accordingly, for a reason similar to that described in relation to the negative electrode 10, it is possible to achieve a superior initial capacity characteristic, a superior load characteristic, and a superior cyclability characteristic.

The secondary battery may include a lithium-ion secondary battery. In such a case, a sufficient battery capacity is obtainable stably by using insertion and extraction of lithium. It is thus possible to achieve higher effects.

Other action and effects related to the secondary battery are similar to those related to the negative electrode 10 described above.

Next, a description is given of modifications according to an embodiment.

The configuration of each of the negative electrode 10 and the secondary battery described above is appropriately modifiable including as described below according to an embodiment. Note that any two or more of the following series of modifications may be combined with each other.

In the above-described manufacturing method (the manufacturing method related to the discontinuous variation) of the negative electrode 10, in order to discontinuously vary each of the average fiber diameter AD, the weight proportion MA, and the void rate R in the thickness direction H, the negative electrode 10 is manufactured by using the lower part 10X and the upper part TOY physically separated from each other, to thereby allow the negative electrode 10 to have the two-layered structure. However, the layer structure of the negative electrode 10 is not limited to the two-layered structure, and may therefore be a structure including three or more layers.

In this case also, as long as one or more of the average fiber diameter AD, the weight proportion MA, or the void rate R vary between the lower part 10X and the upper part TOY, similar effects are obtainable.

As illustrated in FIG. 6 corresponding to FIG. 2, the negative electrode 10 may further include multiple surface parts 3.

The surface parts 3 are each provided on the surface of corresponding one of the covering parts 2, and each have a thickness T2. Further, the surface parts 3 each include any one or more of ion conductive materials. A reason for this is that this improves the negative electrode 10 in ion conductivity. The ion conductive materials are not particularly limited in kind.

Specifically, the ion conductive material is a solid electrolyte such as lithium phosphorous oxynitride or lithium phosphate (Li₃PO₄). The lithium phosphorous oxynitride is not particularly limited in composition, and specific examples of the composition thereof include Li_{3.30}PO_{3.90}N_{0.17}.

Alternatively, the ion conductive material is a gel electrolyte in which an electrolytic solution is held by a matrix polymer compound. The electrolytic solution has a configuration as described above. Specific examples of the matrix polymer compound include polyethylene oxide and polyvinylidene difluoride.

In particular, the ion conductive material preferably includes the solid electrolyte. That is, the ion conductive material preferably includes lithium phosphorous oxynitride, lithium phosphate, or both. A reason for this is that the ion conductivity of the negative electrode 10 sufficiently improves.

Note that the surface part 3 may be provided entirely on the surface of the covering part 2, or may be provided only partially on the surface of the covering part 2. In the latter case, multiple surface parts 3 separate from each other may be provided on the surface of the covering part 2.

The surface parts 3 have an average thickness AT2 that is not particularly limited and may be set as desired. A procedure for calculating the average thickness AT2 is similar to the procedure for calculating the average thickness AT1 described above, except that the thicknesses T2 of the surface parts 3 are measured instead of the thicknesses T1 of the covering parts 2.

A procedure for forming the surface parts 3 is as described below. When using the solid electrolyte as the ion conductive material, the surface parts 3 are formed directly on the surfaces of the covering parts 2 by a vapor-phase method such as a sputtering method. When using the gel electrolyte as the ion conductive material, a solution including the electrolytic solution, the matrix polymer compound, and a solvent for dilution is applied on the surfaces of the covering parts 2, following which the applied solution is dried. Details of the kind of the solvent are as described above. Note that the covering parts 2 and other components may be immersed in the solution.

In this case, the surface parts 3 help to improve the ion conductivity for lithium ions inside the negative electrode 10. It is thus possible to achieve higher effects.

In particular, the use of the surface parts 3 including the ion conductive material allows for application of the negative electrode 10 to an all-solid-state battery. A reason for this is that the expansion and contraction of the negative electrode 10 is suppressed and accordingly, an increase in resistance at an interface between the negative electrode 10 and the solid electrolyte is suppressed. As a result, it is possible for the all-solid-state battery to achieve both ensured safety and an improved energy density.

When the negative electrode 10 includes the surface parts 3 (Modification 2), the average thickness AT2 may be the same between the lower part 10X and the upper part TOY, or may vary between the lower part 10X and the upper part TOY. When the average thickness AT2 varies between the lower part 10X and the upper part TOY, the average thickness AT2 in the lower part 10X may be greater than the average thickness AT2 in the upper part TOY, or may be less than the average thickness AT2 in the upper part TOY. A reason for this is that the ion conductivity for the lithium ions further improves inside the negative electrode 10. Note that a definition of a magnitude relationship regarding the average thickness AT2 is similar to the definition of the magnitude relationship regarding the average fiber diameter AD (the average fiber diameters ADX and ADY) described above.

In particular, the average thickness AT2 in the upper part 10Y is preferably greater than the average thickness AT2 in the lower part 10X. A reason for this is that although the movement speed of the electrode reactant tends to be limited in the upper part 10Y positioned on the side far from the separator in the secondary battery, the ion conductivity for the lithium ions improves in the upper part 10Y, which makes it easier for the lithium ions to move smoothly even if a current value at a time of charging and discharging increases.

When the negative electrode 10 includes the surface parts 3 (Modification 2), a weight proportion MB (wt %) may be the same between the lower part 10X and the upper part 10Y, or may vary between the lower part 10X and the upper part 10Y. The weight proportion MB (wt %) is a proportion of a weight M3 of the surface parts 3 to a sum of the weight M1 of the carbon fiber parts 1, the weight M2 of the covering parts 2, and the weight M3 of the surface parts 3. The weight proportion MB is calculable based on the following calculation expression: MB=[M3/(M1+M2+M3)]×100.

Specifically, the negative electrode 10 has the weight proportion MB as described above, and includes the lower part 10X and the upper part 10Y as illustrated in FIG. 3. The lower part 10X thus has a weight proportion MBX, and the upper part 10Y thus has a weight proportion MBY. The weight proportions MBX and MBY are thus different from each other.

Unlike when the weight proportions MBX and MBY are the same as each other, when the weight proportions MBX and MBY are different from each other, the insertion and extraction of the electrode reactant are further facilitated upon the electrode reaction.

The weight proportion MBX may be greater than the weight proportion MBY, or may be less than the weight proportion MBY. A definition of a magnitude relationship between the weight proportions MBX and MBY is similar to the definition of the magnitude relationship between the weight proportions MAX and MAY described above.

When the negative electrode 10 and the positive electrode are opposed to each other with the separator interposed therebetween in the secondary battery as described above, it is preferable, in particular, that the weight proportion MB be greater in the upper part 10Y than in the lower part 10X, and the weight proportion MBY be thus greater than the weight proportion MBY. A reason for this is that this further facilitates the insertion and extraction of the electrode reactant upon the electrode reaction.

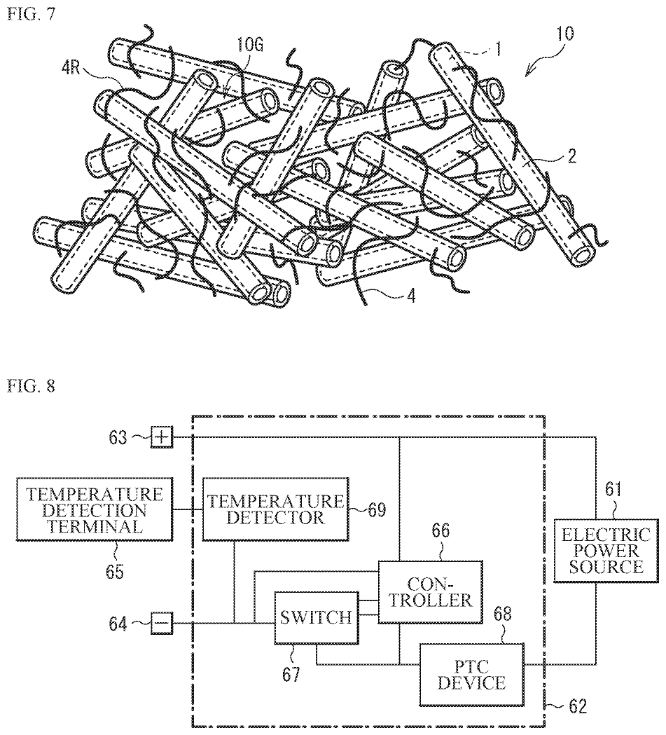

As illustrated in FIG. 7 corresponding to FIG. 1, the negative electrode 10 may further include multiple additional carbon fiber parts 4.

As illustrated in FIG. 7, the additional carbon fiber parts 4 are additional fiber parts that have an average fiber diameter less than the average fiber diameter AD of the carbon fiber parts 1. Here, the additional carbon fiber parts 4 are each fixed on the surface of any of the covering parts 2, and are thus each coupled to the surface of any of the covering parts 2.

For simplifying illustration, FIG. 7 illustrates a case where the additional carbon fiber parts 4 each have a linear shape. However, a state (a shape) of each of the additional carbon fiber parts 4 is not particularly limited, as with the state of each of the carbon fiber parts 1 described above.

When the negative electrode 10 includes the additional carbon fiber parts 4 together with the carbon fiber parts 1, in addition to the electrically conductive network formed by the carbon fiber parts 1, a denser electrically conductive network is formed by the additional carbon fiber parts 4. This markedly improves the electrical conductivity of the negative electrode 10.

In particular, some or all of the additional carbon fiber parts 4, which are denoted as additional carbon fiber parts 4R, are each preferably coupled to two or more of the covering parts 2. A reason for this is that the two or more covering parts 2 are electrically coupled to each other via one or more additional carbon fiber parts 4R. This results in a denser electrically conductive network, which further improves the electrical conductivity of the negative electrode 10.

The additional carbon fiber parts 4 have an average fiber diameter that is less than the average fiber diameter AD of the carbon fiber parts 1 described above. The average fiber diameter of the additional carbon fiber parts 4 is specifically within a range from 1/10000 times the average fiber diameter AD to ½ times the average fiber diameter AD both inclusive, and is preferably within a range from 1/300 times the average fiber diameter AD to ⅕ times the average fiber diameter AD both inclusive. More specifically, the average fiber diameter of the additional carbon fiber parts 4 is within a range from 1 nm to 300 nm both inclusive. A reason for this is that this makes it easier for the additional carbon fiber parts 4 to be dispersed inside the negative electrode 10, and therefore makes it easier for the additional carbon fiber parts 4 to form a denser electrically conductive network.

A procedure for calculating the average fiber diameter of the additional carbon fiber parts 4 is similar to the procedure for calculating the average fiber diameter AD described above, except that the respective fiber diameters of any twenty additional carbon fiber parts 4 are measured and thereafter an average value of the twenty fiber diameters is obtained as the average fiber diameter. Note that when the fiber diameters are small, a TEM is preferably used rather than an SEM to observe the section of the negative electrode 10.

The additional carbon fiber parts 4 each include carbon as a constituent element. Thus, the additional carbon fiber parts 4 each include the carbon-containing material, as with each of the carbon fiber parts 1. Details of the carbon-containing material are as described above.

In particular, the additional carbon fiber parts 4 each preferably include any one or more of the single-walled carbon nanotube, the multi-walled carbon nanotube, or the vapor-grown carbon fiber. A reason for this is that the average fiber diameter becomes sufficiently small, which makes it easier for the additional carbon fiber parts 4 to be sufficiently dispersed inside the negative electrode 10 and makes it easier for a denser electrically conductive network to be formed.

In this case, the electrical conductivity of the negative electrode 10 markedly improves, as described above. It is thus possible to achieve higher effects.

When the negative electrode 10 includes the additional carbon fiber parts 4 (Modification 5), the average fiber diameter of the additional carbon fiber parts 4 may be the same between the lower part 10X and the upper part TOY, or may vary between the lower part 10X and the upper part TOY. When the average fiber diameter varies between the lower part 10X and the upper part 10Y, the average fiber diameter in the lower part 10X may be greater than the average fiber diameter in the upper part 10Y, or may be less than the average fiber diameter in the upper part 10Y. A reason for this is that this makes it easier for a dense electrically conductive network to be formed inside the negative electrode 10, which further improves the electrical conductivity of the negative electrode 10. Note that a definition of a magnitude relationship regarding the average fiber diameter is similar to the above-described definition of the magnitude relationship regarding the average fiber diameter AD (the average fiber diameters ADX and ADY).

In particular, the average fiber diameter in the lower part 10X is preferably less than the average fiber diameter in the upper part 10Y. A reason for this is that this makes it easier for a dense electrically conductive network to be formed in the lower part 10X positioned on the side close to the separator in the secondary battery, which further improves the electrical conductivity of the negative electrode 10.

The separator 33 that is a porous film is used. However, although not specifically illustrated here, a separator of a stacked type including a polymer compound layer may be used instead of the separator 33.

Specifically, the separator of the stacked type includes a porous film having two opposed surfaces, and the polymer compound layer disposed on one of or each of the two opposed surfaces of the porous film. A reason for this is that adherence of the separator to each of the positive electrode 31 and the negative electrode 32 improves to suppress occurrence of winding displacement of the battery device 30. This helps to prevent the secondary battery from swelling easily even if the decomposition reaction of the electrolytic solution occurs. The porous film has a configuration similar to the configuration of the porous film described in relation to the separator 33. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may include any one or more kinds of insulating particles. A reason for this is that the insulating particles facilitate dissipation of heat upon heat generation by the secondary battery, thus improving safety or heat resistance of the secondary battery. The insulating particles include inorganic particles, resin particles, or both. Specific examples of the inorganic particles include particles of materials including, without limitation, aluminum oxide, aluminum nitride, boehmite, silicon oxide, titanium oxide, magnesium oxide, and zirconium oxide. Specific examples of the resin particles include particles of materials including, without limitation, acrylic resin and styrene resin.

When fabricating the separator of the stacked type, a precursor solution including, without limitation, the polymer compound and a solvent is prepared and thereafter, the precursor solution is applied on one of or each of the two opposed surfaces of the porous film. In this case, the porous film may be immersed in the precursor solution instead of applying the precursor solution on the surface(s) of the porous film. The insulating particles may be included in the precursor solution.

When the separator of the stacked type is used also, lithium ions are movable between the positive electrode 31 and the negative electrode 32, and similar effects are therefore obtainable. In this case, in particular, the secondary battery improves in safety, as described above. It is thus possible to achieve higher effects.

The electrolytic solution that is a liquid electrolyte is used. However, although not specifically illustrated here, an electrolyte layer that is a gel electrolyte may be used instead of the electrolytic solution.

In the battery device 30 including the electrolyte layer, the positive electrode 31 and the negative electrode 32 are alternately stacked with the separator 33 and the electrolyte layer interposed therebetween. In this case, the electrolyte layer is interposed between the positive electrode 31 and the separator 33, and between the negative electrode 32 and the separator 33. Note that the electrolyte layer may be interposed only between the positive electrode 31 and the separator 33, or may be interposed only between the negative electrode 32 and the separator 33.

Specifically, the electrolyte layer includes a polymer compound together with the electrolytic solution. The electrolytic solution is held by the polymer compound. A reason for this is that this prevents leakage of the electrolytic solution. The electrolytic solution has a configuration as described above. The polymer compound includes, for example, polyvinylidene difluoride. When forming the electrolyte layer, a precursor solution including, without limitation, the electrolytic solution, the polymer compound, and a solvent for dilution is prepared and thereafter, the precursor solution is applied on one side or both sides of the positive electrode 31 and on one side or both sides of the negative electrode 32. Details of the kind of the solvent are as described above.

When the electrolyte layer is used also, lithium ions are movable between the positive electrode 31 and the negative electrode 32 via the electrolyte layer, and similar effects are therefore obtainable. In this case, in particular, leakage of the electrolytic solution is prevented, as described above. It is thus possible to achieve higher effects.

Lastly, a description is given of applications (application examples) of the secondary battery according to an embodiment.

The applications of the secondary battery are not particularly limited. The secondary battery used as a power source may serve as a main power source or an auxiliary power source of, for example, electronic equipment or an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

One of application examples of the secondary battery will now be described in detail. The configuration described below is merely an example, and is therefore appropriately modifiable.

FIG. 8 illustrates a block configuration of a battery pack. The battery pack described here is a battery pack (what is called a soft pack) including one secondary battery, and is to be mounted on, for example, electronic equipment typified by a smartphone.

As illustrated in FIG. 8, the battery pack includes an electric power source 61 and a circuit board 62. The circuit board 62 is coupled to the electric power source 61, and includes a positive electrode terminal 63, a negative electrode terminal 64, and a temperature detection terminal 65.

The electric power source 61 includes one secondary battery. The secondary battery has a positive electrode lead coupled to the positive electrode terminal 63 and a negative electrode lead coupled to the negative electrode terminal 64. The electric power source 61 is couplable to an outside via the positive electrode terminal 63 and the negative electrode terminal 64, and is thus chargeable and dischargeable. The circuit board 62 includes a controller 66, a switch 67, a thermosensitive resistive (PTC) device 68, and a temperature detector 69. However, the PTC device 68 may be omitted.

The controller 66 includes, for example, a central processing unit (CPU) and a memory, and controls an overall operation of the battery pack. The controller 66 detects and controls a use state of the electric power source 61 on an as-needed basis.

If a voltage of the electric power source 61 (the secondary battery) reaches an overcharge detection voltage or an overdischarge detection voltage, the controller 66 turns off the switch 67. This prevents a charging current from flowing into a current path of the electric power source 61. The overcharge detection voltage is not particularly limited, and is specifically 4.2 V 0.05 V. The overdischarge detection voltage is not particularly limited, and is specifically 2.4 V 0.1 V.

The switch 67 includes, for example, a charge control switch, a discharge control switch, a charging diode, and a discharging diode. The switch 67 performs switching between coupling and decoupling between the electric power source 61 and external equipment in accordance with an instruction from the controller 66. The switch 67 includes, for example, a metal-oxide-semiconductor field-effect transistor (MOSFET). The charging and discharging currents are detected based on an ON-resistance of the switch 67.

The temperature detector 69 includes a temperature detection device such as a thermistor. The temperature detector 69 measures a temperature of the electric power source 61 using the temperature detection terminal 65, and outputs a result of the temperature measurement to the controller 66. The result of the temperature measurement to be obtained by the temperature detector 69 is used, for example, when the controller 66 performs charge and discharge control upon abnormal heat generation or when the controller 66 performs a correction process upon calculating a remaining capacity.

### EXAMPLES

A description is given of Examples of the present technology according to an embodiment.

### Examples 1 to 20 and Comparative Examples 1 to 3

Secondary batteries were fabricated, following which the secondary batteries were evaluated for their characteristics. Here, two kinds of secondary batteries (a first secondary battery and a second secondary battery) were fabricated to evaluate the characteristics of the secondary batteries.

### [Fabrication of First Secondary Battery]

The first secondary battery (Examples 1 to 20 and Comparative example 3) was fabricated in accordance with the following procedure. The first secondary battery was a lithium-ion secondary battery of the laminated film type (having a battery capacity within a range from 7 mAh to 12 mAh both inclusive) illustrated in FIGS. 4 and 5.

In the following description, to describe the process of fabricating the negative electrode 32, reference will be made as necessary to the components of the negative electrode 10 illustrated in FIGS. 1 to 3.

### (Fabrication of Positive Electrode)

First, 97 parts by mass of the positive electrode active material (LiNi_{0.8}Co_{0.15}Al_{0.05}O₂), 2.2 parts by mass of the positive electrode binder (polyvinylidene difluoride), and 0.8 parts by mass of the positive electrode conductor (Ketjen black) were mixed with each other to thereby obtain a positive electrode mixture. Thereafter, the positive electrode mixture was put into a solvent (N-methyl-2-pyrrolidone, i.e., an organic solvent), following which the solvent was stirred by means of a planetary centrifugal mixer to thereby prepare a positive electrode mixture slurry in paste form. Thereafter, by means of a coating apparatus, the positive electrode mixture slurry was applied on one of the two opposed surfaces (excluding the protruding part 31AT) of the positive electrode current collector 31A (an aluminum foil having a thickness of 15 μm) including the protruding part 31AT, following which the applied positive electrode mixture slurry was dried (at a drying temperature of 120° C.) to thereby form the positive electrode active material layer 31B. Lastly, the positive electrode active material layer 31B was compression-molded by means of a hand press machine (to cause the positive electrode active material layer 31B to have a volume density of 3.5 g/cm³). In this manner, the positive electrode 31 including the protruding part 31AT was fabricated.

### (Fabrication of Negative Electrode)

First, to form the lower part 10X, multiple fibrous carbon materials having the average fiber diameter ADX were prepared. As the fibrous carbon material, any of the vapor-grown carbon fiber (VGCF), the carbon nanotube (CNT), or the carbon fiber (CF) was used in accordance with the average fiber diameter ADX. Note that the average fiber diameter ADX (nm) was as listed in Tables 1 and 2.

Thereafter, the covering parts 2 (having the weight proportion MAX) were formed by depositing the silicon-containing material (a simple substance of silicon (Si)) on the respective surfaces of the fibrous carbon materials by a vacuum deposition method. In this case, silicon (having a purity of 99.9%) was used as a deposition source. Two deposition sources were thus so disposed as to allow the fibrous carbon materials to be interposed therebetween. The deposition of the silicon-containing material was not performed on a portion of the fibrous carbon materials to allow the portion of the fibrous carbon materials with no covering parts 2 being formed thereon to serve as the protruding parts 32AT. Note that the weight proportion MAX (wt %) was as listed in Tables 1 and 2.

Thereafter, to form the upper part 10Y, the covering parts 2 having the weight proportion MAY were formed by using multiple fibrous carbon materials having the average fiber diameter ADY by a similar procedure.

Thereafter, the two kinds of fibrous carbon materials on which the covering parts 2 described above were formed were combined with each other by means of an apparatus for combining multiple layers of paper sheets. Accordingly, the lower part 10X including the carbon fiber parts 1 and the covering parts 2, and the upper part 10Y including the carbon fiber parts 1 and the covering parts 2 were formed. In addition, the lower part 10X and the upper part 10Y were stacked on each other. As a result, the negative electrode 32 was assembled.

Lastly, the negative electrode 32 was pressed in an ambient temperature environment (at a temperature of 23° C.), following which the negative electrode 32 was heated (at a heating temperature of 350° C. for a heating time of 3 hours) in a nitrogen (N₂) atmosphere.

In such a manner, completed was the negative electrode 32 of the two-layered structure including the lower part 10X with the void rate RX and the upper part 10Y with the void rate RY, and having the voids 10G. Note that the void rate RX (vol %) was as listed in Tables 1 and 2.

When fabricating the negative electrode 32, the weight proportions MAX and MAY were varied by adjusting an amount of deposition of the silicon-containing material, and the void rates RX and RY were varied by adjusting each of the amount of deposition of the silicon-containing material and a pressure applied in pressing the negative electrode 32.

Here, as described in Tables 1 and 2, one or more of the three physical property values, i.e., the average fiber diameter AD, the weight proportion MA, and the void rate R were caused to vary between the lower part 10X and the upper part 10Y. The “ratio” listed in Tables 1 and 2 refers to a ratio defining the magnitude relationship regarding each of the physical property values, i.e., the average fiber diameters ADX and ADY, the weight proportions MAX and MAY, and the void rates RX and RT.

Specifically, the “ratio” regarding the average fiber diameter AD refers to the ratio (=ADX/ADY) of the average fiber diameter ADX to the average fiber diameter ADY. Thus, the ratio less than 1 indicates that the average fiber diameter ADX was less than the average fiber diameter ADY.

The “ratio” regarding the weight proportion MA refers to the ratio (=MAX/MAY) of the weight proportion MAX to the weight proportion MAY. Thus, the ratio greater than 1 indicates that the weight proportion MAX was greater than the weight proportion MAY.

The “ratio” regarding the void rate R refers to the ratio of the void rate RY to the void rate RX. Thus, the ratio greater than 1 indicates that the void rate RY was greater than the void rate RX.

### (Preparation of Electrolytic Solution)

The electrolyte salt (lithium hexafluorophosphate) was added to the solvent, following which the solvent was stirred. Used as the solvent were ethylene carbonate as the cyclic carbonic acid ester, dimethyl carbonate as the chain carbonic acid ester, and monofluoroethylene carbonate as the additive (the halogenated cyclic carbonic acid ester). A mixture ratio (a weight ratio) between ethylene carbonate, dimethyl carbonate, and monofluoroethylene carbonate in the solvent was set to 30:60:10. The content of the electrolyte salt with respect to the solvent was set to 1 mol/kg. The electrolytic solution was thus prepared.

### (Assembly of First Secondary Battery)

First, the positive electrodes 31 including the protruding parts 31AT and the negative electrodes 32 including the protruding parts 32AT were alternately stacked on each other with the separators 33 (fine porous polyethylene films each having a thickness of 20 μm) each interposed between corresponding one of the positive electrodes 31 and corresponding one of the negative electrodes 32 to thereby fabricate the stacked body (the positive electrode 31/the separator 33/the negative electrode 32).

Thereafter, the positive electrode lead 41 (an aluminum foil) was joined to the protruding parts 31AT, and the negative electrode lead 42 (a copper foil) was joined to the protruding parts 32AT.

Thereafter, the outer package film 20 (the fusion-bonding layer/the metal layer/the surface protective layer) was so folded as to sandwich the stacked body placed inside the depression part 20U, following which the outer edge parts of two sides of the outer package film 20 (the fusion-bonding layer) were thermal-fusion-bonded to each other to thereby allow the stacked body to be contained inside the outer package film 20 having the pouch shape. As the outer package film 20, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side.

Lastly, the electrolytic solution was injected into the outer package film 20 having the pouch shape, following which the outer edge parts of the remaining one side of the outer package film 20 (the fusion-bonding layer) were thermal-fusion-bonded to each other in a reduced pressure environment. In this case, the sealing film 51 (a polypropylene film having a thickness of 5 μm) was interposed between the outer package film 20 and the positive electrode lead 41, and the sealing film 52 (a polypropylene film having a thickness of 5 μm) was interposed between the outer package film 20 and the negative electrode lead 42.

The stacked body was thereby impregnated with the electrolytic solution, and the battery device 30 was thus fabricated. In this manner, the battery device 30 was sealed in the outer package film 20, and the secondary battery was thus assembled.

When assembling the first secondary battery, a thickness of the positive electrode active material layer 31B was so adjusted as to allow a capacity ratio, i.e., a ratio of a charge capacity of the positive electrode to the charge capacity of the negative electrode (=charge capacity of positive electrode/charge capacity of negative electrode), to be 0.7.

### (Stabilization of First Secondary Battery)

The first secondary battery was charged and discharged for one cycle in an ambient temperature environment (at a temperature of 23° C.). Upon the charging, the first secondary battery was charged with a constant current of 0.1 C until a voltage reached 4.2 V, and was thereafter charged with a constant voltage of 4.2 V until a current reached 0.025 C. Upon the discharging, the first secondary battery was discharged with a constant current of 0.1 C until the voltage reached 2.0 V. Note that 0.1 C was a value of a current that caused a battery capacity (a theoretical capacity) to be completely discharged in 10 hours, and 0.025 C was a value of a current that caused the battery capacity to be completely discharged in 40 hours.

As a result, a film was formed on the surface of each of the positive electrode 31 and the negative electrode 32, which brought the first secondary battery into an electrochemically stable state. Thus, the first secondary battery was completed.

### [Fabrication of Second Secondary Battery]

The second secondary battery (having a battery capacity within a range from 10 mAh to 15 mAh both inclusive) was fabricated by a procedure similar to the fabrication procedure of the first secondary battery described above, except that a lithium metal plate (having a thickness of 100 μm) was used instead of the positive electrode 31.

Here, the first secondary battery including the positive electrode 31 as a counter electrode to the negative electrode 32 was what is called a full cell, whereas the second secondary battery including the lithium metal plate as the counter electrode to the negative electrode 32 was what is called a half cell.

### [Fabrication of Secondary Battery for Comparison]

Note that, for the purpose of comparison, two kinds of secondary batteries for comparison (Comparative examples 1 and 2) were fabricated by a similar procedure except that a negative electrode for comparison was fabricated using a metal current collector.

When fabricating such a negative electrode, first, 82 parts by mass of a negative electrode active material (a simple substance of silicon (Si) having a purity of 95% and a median diameter D50 of 50 nm), 10 parts by mass (in terms of solids content) of a negative electrode binder (polyimide), 3 parts by mass of a negative electrode conductor (carbon black), and 5 parts by mass of another negative electrode conductor (a carbon nanotube dispersion) were mixed with each other to thereby obtain a negative electrode mixture. The carbon nanotube dispersion included 0.8 parts by mass of carbon nanotubes and 4.2 parts by mass of a dispersion medium (polyvinylidene difluoride).

Thereafter, the negative electrode mixture was put into a solvent (N-methyl-2-pyrrolidone, i.e., an organic solvent), following which the organic solvent was stirred by means of a planetary centrifugal mixer to thereby prepare a negative electrode mixture slurry in paste form. Thereafter, by means of a coating apparatus, the negative electrode mixture slurry was applied on two opposed surfaces of a negative electrode current collector (a copper foil (Cu) having a thickness of 10 μm or 6 μm), i.e., the metal current collector, following which the applied negative electrode mixture slurry was dried to thereby form negative electrode active material layers. The negative electrode was thereby assembled.

Lastly, the negative electrode was pressed in an ambient temperature environment (at a temperature of 23° C.), following which the negative electrode was heated (at a heating temperature of 350° C. for a heating time of 3 hours) in a nitrogen atmosphere.

Note that the “Metal current collector (thickness)” column in Tables 1 and 2 indicates the presence or absence of the metal current collector and, when the metal current collector was used, also indicates a material and a thickness (μm) thereof.

### [Characteristic Evaluation of Secondary Battery]

Evaluation of the secondary batteries for their characteristics (their initial capacity characteristics, load characteristics, and cyclability characteristics) revealed the results presented in Tables 1 and 2.

In this case, by respective procedures described below, the initial capacity characteristic was evaluated using the second secondary battery (a half cell), and the load characteristic and the cyclability characteristic were each evaluated using the first secondary battery (a full cell).

### (Initial Capacity Characteristic)

The secondary battery was charged and discharged for one cycle in an ambient temperature environment (at a temperature of 23° C.) while applying pressure to the secondary battery to thereby measure the discharge capacity. An initial capacity as an index for evaluating the initial capacity characteristic was thus calculated based on the following calculation expression: initial capacity (mAh/g)=discharge capacity (mAh)/total weight (g) of negative electrode 32.

In this case, the secondary battery was charged and discharged while causing the positive electrode 31 and the negative electrode 32 to be in close contact with each other with the separator 33 interposed therebetween, by applying pressure to the secondary battery in a direction in which the positive electrode 31 and the negative electrode 32 were stacked on each other with the separator 33 interposed therebetween. Note that when the metal current collector was used, the total weight of the negative electrode 32 described above included a weight of the metal current collector, and when the metal current collector was not used, the total weight of the negative electrode 32 described above did not include the weight of the metal current collector.

Upon the charging, the secondary battery was charged with a constant current of 0.1 C until a voltage reached 0.005 V, and was thereafter charged with a constant voltage of 0.005 V until a current reached 0.01 C. Upon the discharging, the secondary battery was discharged with a constant current of 0.1 C until the voltage reached 1.5 V. Note that 0.01 C was a value of a current that caused the battery capacity to be completely discharged in 100 hours.

### (Load Characteristic)

First, the secondary battery was charged and discharged for one cycle in an ambient temperature environment (at a temperature of 23° C.) to thereby measure the discharge capacity (a first-cycle discharge capacity).

Upon the charging, the secondary battery was charged with a constant current of 0.2 C until a voltage reached 4.2 V, and was thereafter charged with a constant voltage of 4.2 V until a current reached 0.025 C. Upon the discharging, the secondary battery was discharged with a constant current of 0.2 C until the voltage reached 2.5 V. Note that 0.2 C was a value of a current that caused the battery capacity to be completely discharged in 5 hours.

Thereafter, the secondary battery was charged and discharged for one cycle in the same environment to thereby measure the discharge capacity (a second-cycle discharge capacity). Charging and discharging conditions were similar to those in the first cycle except that the current at the time of the charging and the current at the time of the discharging were each changed to 5 C. Note that 5 C was a value of a current that caused the battery capacity to be completely discharged in 0.2 hours.

Lastly, a load retention rate as an index for evaluating the load characteristic was calculated based on the following calculation expression: load retention rate (%)=(second-cycle discharge capacity/first-cycle discharge capacity)×100.

### (Cyclability Characteristic)

First, the secondary battery was charged and discharged for one cycle in an ambient temperature environment (at a temperature of 23) to thereby measure the discharge capacity (a first-cycle discharge capacity). Thereafter, the secondary battery was charged and discharged for 199 cycles in the same environment to thereby measure the discharge capacity (a 200th-cycle discharge capacity). Charging and discharging conditions were similar to those in the first cycle in the case of evaluating the load characteristic described above.

Lastly, a capacity retention rate as an index for evaluating the cyclability characteristic was calculated based on the following calculation expression: capacity retention rate (%)=(200th-cycle discharge capacity/first-cycle discharge capacity)×100.

### (Normalization of Characteristic Value)

Note that values of the initial capacity listed in Tables 1 and 2 are normalized values that were obtained with respect to the value of the initial capacity of the secondary battery of Comparative example 1 including the metal current collector (the copper foil having the thickness of 10 m) assumed to be 100. Similarly, values of each of the load retention rate and the capacity retention rate are also normalized values that were obtained with respect to corresponding values of the secondary battery of Comparative example 1.

TABLE 1

| | | | Covering part | | | | | | | | | |
|---|---|---|---|---|---|---|---|---|---|---|---|---|
| | Carbon | | Negative electrode | | | | | | Metal | | | |
| | fiber part | | active material | | RX | | | | current | | Load | Capacity |
| | | ADX | | MAX | (vol | Ratio | | | collector | Initial | retention | retention |
| | Kind | (nm) | Kind | (wt %) | %) | AD | MA | R | (Thickness) | capacity | rate | rate |
| Example 1 | VGCF | 200 | Si | 61 | 44 | 0.03 | 1 | 1 | — | 121 | 128 | 109 |
| Example 2 | VGCF | 200 | Si | 69 | 64 | 0.03 | 1.43 | 1 | — | 190 | 208 | 226 |
| Example 3 | VGCF | 200 | Si | 69 | 51 | 0.03 | 1.43 | 1.6 | — | 211 | 220 | 229 |
| Example 4 | VGCF | 200 | Si | 69 | 64 | 1 | 1.43 | 1 | — | 139 | 140 | 155 |
| Example 5 | VGCF | 200 | Si | 68 | 51 | 1 | 1.43 | 1.6 | — | 123 | 146 | 189 |
| Example 6 | VGCF | 200 | Si | 61 | 52 | 1 | 1 | 1.6 | — | 119 | 185 | 132 |
| Example 7 | VGCF | 200 | Si | 63 | 51 | 0.03 | 1 | 1.6 | — | 145 | 190 | 187 |
| Example 8 | CNT | 1 | Si | 62 | 64 | 0.0002 | 1 | 1 | — | 125 | 104 | 106 |
| Example 9 | CNT | 5 | Si | 62 | 64 | 0.0003 | 1 | 1 | — | 138 | 144 | 145 |
| Example 10 | CNT | 20 | Si | 61 | 64 | 0.1 | 1 | 1 | — | 160 | 131 | 126 |
| Example 11 | VGCF | 200 | Si | 60 | 64 | 0.5 | 1 | 1 | — | 123 | 140 | 120 |
| Example 12 | CF | 200 | Si | 61 | 64 | 0.7 | 1 | 1 | — | 121 | 105 | 132 |

TABLE 2

| | | | Covering part | | | | | | | | | |
|---|---|---|---|---|---|---|---|---|---|---|---|---|
| | Carbon | | Negative electrode | | | | | | Metal | | | |
| | fiber part | | active material | | RX | | | | current | | Load | Capacity |
| | | ADX | | MAX | (vol | Ratio | | | collector | Initial | retention | retention |
| | Kind | (nm) | Kind | (wt %) | %) | AD | MA | R | (Thickness) | capacity | rate | rate |
| Example 13 | VGCF | 200 | Si | 59 | 63 | 1 | 0.5 | 1 | — | 108 | 129 | 106 |
| Example 14 | VGCF | 200 | Si | 81 | 63 | 1 | 1.04 | 1 | — | 103 | 101 | 132 |
| Example 15 | VGCF | 200 | Si | 73 | 61 | 1 | 3.00 | 1 | — | 155 | 172 | 163 |
| Example 16 | VGCF | 200 | Si | 55 | 61 | 1 | 4.65 | 1 | — | 156 | 165 | 141 |
| Example 17 | VGCF | 200 | Si | 58 | 62 | 1 | 5 | 1 | — | 135 | 122 | 101 |
| Example 18 | VGCF | 200 | Si | 61 | 80 | 1 | 1 | 0.5 | — | 101 | 102 | 117 |
| Example 19 | VGCF | 200 | Si | 62 | 57 | 1 | 1 | 1.1 | — | 106 | 120 | 125 |
| Example 20 | VGCF | 200 | Si | 63 | 20 | 1 | 1 | 4.5 | — | 110 | 158 | 131 |
| Comparative | — | — | Si | — | 44 | — | — | 1 | Cu | 100 | 100 | 100 |
| example 1 | | | | | | | | | (10 μm) | | | |
| Comparative | — | — | Si | — | 44 | — | — | 1 | Cu | 107 | 77 | 64 |
| example 2 | | | | | | | | | (6 μm) | | | |
| Comparative | VGCF | 200 | Si | 60 | 64 | 1 | 1 | 1 | — | 92 | 102 | 114 |
| example 3 | | | | | | | | | | | | |

As indicated in Tables 1 and 2, the initial capacity, the load retention rate, and the capacity retention rate each varied greatly depending on the configuration of the negative electrode. In the following description, respective values of the initial capacity, the load retention rate, and the capacity retention rate in Comparative example 1 are each taken as a comparative reference.

Specifically, when the metal current collector was used, decreasing the thickness of the metal current collector (Comparative example 2) increased the initial capacity, but resulted in a decrease in each of the load retention rate and the capacity retention rate.

In contrast, when the carbon fiber parts 1 and the covering parts 2 were used without using the metal current collector (Examples 1 to 20 and Comparative example 3), the initial capacity, the load retention rate, and the capacity retention rate each varied depending on their configurations.

That is, when each of the average fiber diameter AD, the weight proportion MA, and the void rate R was the same between the lower part 10X and the upper part TOY (Comparative example 3), the load retention rate and the capacity retention rate each increased, but the initial capacity greatly decreased.

However, when one or more of the average fiber diameter AD, the weight proportion MA, or the void rate R varied between the lower part 10X and the upper part TOY (Examples 1 to 20), the initial capacity, the load retention rate, and the capacity retention rate each increased.

In this case, if the average fiber diameter ADX was less than the average fiber diameter ADY, in particular, the initial capacity, the load retention rate, and the capacity retention rate each increased. If the weight proportion MAX was greater than the weight proportion MAY, the initial capacity, the load retention rate, and the capacity retention rate each increased. If the void rate RY was greater than the void rate RX, the initial capacity, the load retention rate, and the capacity retention rate each increased.

In addition, if the ratio regarding the average fiber diameter AD was within a range from 0.0003 to 0.5 both inclusive, the initial capacity, the load retention rate, and the capacity retention rate each sufficiently increased. If the ratio regarding the weight proportion MA was within a range from 1.04 to 4.65 both inclusive, the initial capacity, the load retention rate, and the capacity retention rate each sufficiently increased. If the ratio regarding the void rate R was within a range from 1.1 to 4.5 both inclusive, the initial capacity, the load retention rate, and the capacity retention rate each sufficiently increased.

### Examples 21 to 23

As described in Table 3, secondary batteries were fabricated and thereafter evaluated for their characteristics (their initial capacity characteristics, load characteristics, and cyclability characteristics) in accordance with procedures similar to those for Example 1 except that the surface parts 3 including the ion conductive material were formed in the process of fabricating the negative electrode 32.

As the ion conductive material, lithium phosphorous oxynitride (Li_{3.30}PO_{3.90}N_{0.17}) or lithium phosphate (Li₃PO₄) was used. The average thickness AT2 (nm) of the surface parts 3 in the lower part 10X was as listed in Table 3.

The “Ratio” listed in Table 3 refers to a ratio of the average thickness AT2 in the upper part 10Y to the average thickness AT2 in the lower part 10X (=average thickness AT2 in upper part 10Y/average thickness AT2 in lower part 10X). Thus, the ratio greater than 1 indicates that the average thickness AT2 in the upper part 10Y was greater than the average thickness AT2 in the lower part 10X.

When forming the surface parts 3, the ion conductive material was deposited onto the surface of each of the covering parts 2 by a sputtering method. Note that when forming the surface parts 3 including lithium phosphate, lithium phosphate was used as a target, and when forming the surface parts 3 including lithium phosphorous oxynitride, lithium phosphate was used as a target in a nitrogen atmosphere.

TABLE 3

| | Surface part | | | | Load | Capacity |
|---|---|---|---|---|---|---|
| | | AT2 | | Initial | retention | retention |
| | Kind | (nm) | Ratio | capacity | rate | rate |
| Ex- | — | — | — | 121 | 128 | 109 |
| ample 1 | | | | | | |
| Ex- | Li_{3.30}PO_{3.90}N_{0.17} | 11 | 1 | 140 | 169 | 148 |
| ample 21 | | | | | | |
| Ex- | Li₃PO₄ | 8 | 1 | 138 | 164 | 152 |
| ample 22 | | | | | | |
| Ex- | Li₃PO₄ | 7 | 3 | 143 | 192 | 177 |
| ample 23 | | | | | | |

As indicated in Table 3, when the surface parts 3 were formed (Examples 21 to 23), the initial capacity, the load retention rate, and the capacity retention rate each increased further, as compared with when no surface parts 3 were formed (Example 1). In particular, when the surface parts 3 were formed, increasing the ratio regarding the average thickness AT2 resulted in a further increase in each of the initial capacity, the load retention rate, and the capacity retention rate.

The results presented in Tables 1 to 3 indicate that when: the negative electrode 32 (the negative electrode 10) included the carbon fiber parts 1 and the covering parts 2 described above and had the voids 10G; and one or more of the average fiber diameter AD, the weight proportion MA, or the void rate R varied between the lower part 10X and the upper part 10Y, the initial capacity, the load retention rate, and the capacity retention rate each increased. It was thus possible for the secondary battery to achieve a superior initial capacity characteristic, a superior load characteristic, and a superior cyclability characteristic.

The configuration of the present technology is not limited to the description herein, and is therefore modifiable in a variety of suitable ways.

For example, the description has been given of the case where the secondary battery has a battery structure of the laminated-film type. However, the battery structure of the secondary battery is not particularly limited, and may be of any other type, such as a cylindrical type, a prismatic type, a coin type, or a button type.

Further, the description has been given of the case where the battery device has a device structure of the stacked type. However, the device structure of the battery device is not particularly limited, and may be of any other type, such as a wound type or a zigzag folded type. In the wound type, the positive electrode and the negative electrode are wound with the separator interposed therebetween. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. For example, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including fiber parts and covering parts, and having voids;
a separator disposed between the positive electrode and the negative electrode; and
an electrolytic solution, wherein
the fiber parts are coupled to each other to thereby form a three-dimensional mesh structure having the voids, the fiber parts each including carbon as a constituent element,
the covering parts each cover a surface of corresponding one of the fiber parts, and each include silicon as a constituent element, and
where the negative electrode is bisected into a first part and a second part in a direction in which the positive electrode and the negative electrode are opposed to each other with the separator interposed between the positive electrode and the negative electrode, at least one of an average fiber diameter of the fiber parts, a proportion of a weight of the covering parts to a sum of a weight of the fiber parts and the weight of the covering parts, or a void rate varies between the first part and the second part, the first part being positioned on a side close to the separator, the second part being positioned on a side far from the separator.

2. The secondary battery according to claim 1, wherein the average fiber diameter of the fiber parts in the first part is less than the average fiber diameter of the fiber parts in the second part.

3. The secondary battery according to claim 2, wherein the average fiber diameter of the fiber parts in the first part is greater than or equal to 0.0003 times the average fiber diameter of the fiber parts in the second part and less than or equal to 0.5 times the average fiber diameter of the fiber parts in the second part.

4. The secondary battery according to claim 1, wherein the proportion in the first part is greater than the proportion in the second part.

5. The secondary battery according to claim 4, wherein the proportion in the first part is greater than or equal to 1.04 times the proportion in the second part and less than or equal to 4.65 times the proportion in the second part.

6. The secondary battery according to claim 1, wherein the void rate in the second part is greater than the void rate in the first part.

7. The secondary battery according to claim 6, wherein the void rate in the second part is greater than or equal to 1.1 times the void rate in the first part and less than or equal to 4.5 times the void rate in the first part.

8. The secondary battery according to claim 1, wherein
the average fiber diameter of the negative electrode is greater than or equal to 10 nanometers and less than or equal to 12000 nanometers,
the proportion of the negative electrode is greater than or equal to 40 weight percent and less than or equal to 80 weight percent, and
the void rate in the whole of the negative electrode is greater than or equal to 40 volume percent and less than or equal to 70 volume percent.

9. The secondary battery according to claim 1, wherein a content of silicon in each of the covering parts is greater than or equal to 80 weight percent.

10. The secondary battery according to claim 1, wherein
the negative electrode further includes surface parts each provided on a surface of corresponding one of the covering parts, and
the surface parts each include an ion conductive material.

11. The secondary battery according to claim 10, wherein the ion conductive material includes lithium phosphorous oxynitride, lithium phosphate, or both.

12. The secondary battery according to claim 10, wherein the surface parts have an average thickness that varies between the first part and the second part.

13. The secondary battery according to claim 12, wherein the average thickness in the second part is greater than the average thickness in the first part.

14. The secondary battery according to claim 1, wherein
the negative electrode further includes additional fiber parts having an average fiber diameter less than the average fiber diameter of the fiber parts, and
at least some of the additional fiber parts are each coupled to a surface of corresponding one of the covering parts, the additional fiber parts each including carbon as a constituent element.

15. The secondary battery according to claim 14, wherein the average fiber diameter of the additional fiber parts varies between the first part and the second part.

16. The secondary battery according to claim 15, wherein the average fiber diameter of the additional fiber parts in the first part is less than the average fiber diameter of the additional fiber parts in the second part.

17. The secondary battery according to claim 1, wherein the secondary battery comprises a lithium-ion secondary battery.

18. A negative electrode for a secondary battery, the negative electrode comprising
fiber parts and covering parts,
the negative electrode having voids, wherein
the fiber parts are coupled to each other to thereby form a three-dimensional mesh structure having the voids, the fiber parts each including carbon as a constituent element,
the covering parts each cover a surface of corresponding one of the fiber parts, and each include silicon as a constituent element, and
where the negative electrode is bisected into a first part and a second part in a thickness direction, at least one of an average fiber diameter of the fiber parts, a proportion of a weight of the covering parts to a sum of a weight of the fiber parts and the weight of the covering parts, or a void rate varies between the first part and the second part.
